(19) United States
(12) Patent Application Publication
(10) Pub. No.: US 2005/0004901 A1
(43) Pub. Date: Jan. 6, 2005

(54) Data consistency detection device, data consistency detection method and data selection device

(75) Inventors: Norihiko Mizobata, Osaka (JP); Koichi Tsutsumi, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/880,665

(22) Filed: Jul. 1, 2004

(30) Foreign Application Priority Data
Jul. 4, 2003 (JP) 2003-192043
Jun. 28, 2004 (JP) 2004-189576

(51) Int. Cl. G06F 7/00

(52) U.S. Cl. 707/3

(57) ABSTRACT

A first memory stores in advance, in an address assigned to each of possible values that each of the plurality of data segments can have, reference data which indicates that the possible value is consistent with the detection condition (“consistency”) or reference data which indicates that the possible value is inconsistent with the detection condition (“inconsistency”) based on the detection condition. A data extraction section sequentially extracts a data segment from the input data to supply an address corresponding to a value of the extracted data segment to the first memory. The first memory outputs reference data stored in the address supplied from the data extraction section. A determination section determines whether or not the input data is consistent with the detection condition based on the reference data output from the first memory.

### CROSS-REFERENCE TO RELATED APPLICATIONS

This application claims priority under 35 U.S.C. §119(a) on Japanese Patent Application No. 2003-192043 filed on Jul. 4, 2003 and Japanese Patent Application No. 2004-189576 filed on Jun. 28, 2004, the entire contents of which are hereby incorporated by reference.

### BACKGROUND OF THE INVENTION

1. Field of the Invention

The present invention relates to a data consistency detection device, a data consistency detection method and a data selection device. Specifically, the present invention relates to a device and method for detecting whether or not data to be received from among data received through a broadcast, digital data output from a recording device, etc., is consistent with a predetermined detection condition, and a device for selecting the data consistent with the predetermined detection condition.

2. Description of the Related Art

In recent years, video data, audio data, or the like, is in many cases transferred/accumulated in the form of digital data. Generally, in such a case, data is divided and converted to data having a data structure consisting of some fields, such as a packet, or the like, and the converted data is transferred/accumulated. After conversion to a plurality of data packets, the data packets are multiplexed into a single transfer/accumulation medium before transferred/accumulated in some cases. An example of the standards for the data structure and multiplexation for such a case is the MPEG system standard. In many cases, transfer/accumulation of data is carried out using a method compliant with a packet data structure of the MPEG standard.

In such a system where packet data is multiplexed, it is necessary to select data to be received from multiplexed packet data at a data receiving device. Especially, various information associated with a program, such as PSI (program specific information), SI (service information), and the like, are repeatedly transferred based on a data format called “section”. However, information required differs depending on the status of a receiver, e.g., which program is selected and received by the receiver, and thus, the required information must be appropriately selected from an enormous amount of information.

A demultiplexer for selecting section data, which is used in a receiver for digital broadcasts based on a data multiplexation method compliant with the MPEG system standard, is now described as an example of conventional techniques.

In the conventional demultiplexer, every time one section data is input, each of the fields that constitute the section data is compared with all candidate data corresponding to the field. Consistency with the candidate data is sequentially checked for all of the input fields to be compared. If it is detected that all of the fields are consistent with the candidate data, it is determined that this section data is to be received, and this section data is selected and output. Furthermore, a circuit for masking comparison of candidate data and input fields to disable consistency detection and a circuit for detecting inconsistency with candidate date are provided to achieve flexible data selection (see Japanese Unexamined Patent Publication No. 11-164271).

### SUMMARY OF THE INVENTION

However, the section data consistency detection device and selection device of the conventional demultiplexer have a problem described below.

In a demultiplexer of a general digital broadcast receiver, the following section data selection properties:
Comparison target field . . . leading 16 bytes of section data;
Candidate date type . . . 32 types (with comparison mask)
Input rate of section data of selection target . . . 12.5 Mbytes/sec
Operation clock frequency of section data selection device . . . 100 MHz

In the case of a section data consistency detection device having the above properties, comparison of input fields and candidate data has to be performed at 12.5 Mbytes/sec×32 types=400 M times/sec. In this case, the read rate of reading from a candidate data memory which stores candidate data and comparison mask data is 400 M times/sec×2 bytes=800 Mbytes/sec. In order to achieve comparison of 400 M times with a circuit that operates at the operation clock of 100 MHz, the comparison has to be performed 4 times within one clock cycle. In order to perform comparison 4 times, it is necessary to read candidate data of 4 bytes and comparison mask data of 4 bytes, i.e., data of 8 bytes in total, within one clock cycle. Accordingly, the required data width of the data read from the candidate data memory is 8 bytes. Thus, in the conventional section data consistency detection device, data comparison has to be executed at 400 Mbytes/sec while reading data from the candidate data memory of 8 byte width at 100 M times/sec (800 Mbytes/sec).

Only an LSI incorporated memory is a practical example of the candidate data memory having such a high bandwidth. Further, it is necessary to provide an exclusive data comparison circuit in order to execute the above-described high-speed data consistency detection. Thus, a high-performance section data consistency detection device has been realized by hardware. Furthermore, in order to realize a higher-performance section data consistency detection device, the data width that can be read out within one clock cycle has to be extended for increasing the memory bandwidth, and in addition, the number of pieces of candidate data that the data comparison circuit can compare within one clock cycle has to be increased.

A data consistency detection device of the present invention is a device for determining whether or not input data including a plurality of data segments is consistent with a predetermined detection condition, the device comprising: a first memory for storing in advance, in an address assigned to each of possible values that each of the plurality of data segments can have, reference data which indicates that the possible value is consistent with the detection condition (“consistency”) or reference data which indicates that the possible value is inconsistent with the detection condition (“inconsistency”) based on the detection condition; and a data extraction section for sequentially extracting a data segment from the input data to supply an address corresponding to a value of the extracted data segment to the first memory, wherein the first memory outputs reference data stored in the address supplied from the data extraction section, and the data consistency detection device further comprises a determination section for determining whether or not the input data is consistent with the detection condition based on the reference data output from the first memory.

In the above data consistency detection device, consistency detection between the input data and the detection condition is realized only by a single reading operation of reading one data segment from the first memory. Thus, it is not necessary to read all of the consistency detection candidate data for comparison with one data segment, which is required in the conventional techniques. Thus, the number of times of memory accesses and the number of times of a comparison operation are greatly decreased.

Preferably, in the above data consistency detection device, the detection condition includes a first detection condition; and the reference data stored in the first memory in advance includes first data in which one of first and second values is set based on the first detection condition.

Preferably, in the above data consistency detection device, the detection condition further includes a second detection condition; and the reference data stored in the first memory in advance includes second data in which one of the first and second values is set based on the second detection condition.

Preferably, in the above data consistency detection device, if the reference data output from the first memory indicates “consistency” for all of the plurality of data segments included in the input data, the determination section determines that the input data is consistent with the detection condition.

Preferably, in the above data consistency detection device, the first memory stores the reference data in advance in an address generated based on a position of each of the plurality of data segments in the input data and each of the possible values that the data segment can have; and a data extraction section supplies to the first memory an address generated based on a position of the extracted data segment in the input data and a value of the extracted data segment.

Preferably, in the above data consistency detection device, each of the plurality of data segments constitutes one piece of byte data.

Preferably, in the above data consistency detection device, each of the plurality of data segments constitutes one piece of field data.

Preferably, in the above data consistency detection device, the determination section includes a logical operation section and a second memory for storing output data of the logical operation section; if both the reference data output from the first memory and the output data stored in the second memory indicate “consistency”, the logical operation section outputs the data which indicates “consistency”; if at least one of the reference data output from the first memory and the output data stored in the second memory indicates “inconsistency”, the logical operation section outputs the data which indicates “inconsistency”; the second memory stores the data which indicates “consistency” as an initial value; and the second memory outputs, as consistency determination information, the output data of the logical operation section for the last one of the plurality of data segments extracted from the input data by the data extraction section.

Preferably, in the above data consistency detection device, a predetermined arithmetic operation is assigned to each of the plurality of data segments; the determination section includes a logical operation section and a second memory for storing output data of the logical operation section; the logical operation section performs an arithmetic operation assigned to a data segment which corresponds to the reference data output from the first memory on at least one of the reference data and the output data stored in the second memory to output a result of the arithmetic operation; the second memory stores the data which indicates “consistency” as an initial value; and the second memory outputs, as consistency determination information, the output data of the logical operation section for the last one of the plurality of data segments extracted from the input data by the data extraction section.

Preferably, in the above data consistency detection device, the second memory is capable of storing a plurality of pieces of the output data of the logical operation section; and the logical operation section performs an arithmetic operation assigned to a data segment which corresponds to the reference data output from the first memory on at least one of the reference data and the plurality of pieces of output data stored in the second memory to output a result of the arithmetic operation.

A data selection device of the present invention comprises: the above data consistency detection device; and a data delay section for retaining the input data till the determination performed in the data consistency detection device as to whether or not the input data is consistent with the detection condition is completed, wherein if the data consistency detection device determines that the input data is consistent with the detection condition, the data delay section outputs the retained input data, and if the data consistency detection device determines that the input data is inconsistent with the detection condition, the data delay section does not output the retained input data.

A data consistency detection method of the present invention is a method for determining whether or not input data including a plurality of data segments is consistent with a predetermined detection condition, the method comprising: step (a) of storing in a first memory in advance, at an address assigned to each of possible values that each of the plurality of data segments can have, reference data which indicates that the possible value is consistent with the detection condition (“consistency”) or reference data which indicates that the possible value is inconsistent with the detection condition (“inconsistency”) based on the detection condition; step (b) of sequentially extracting a data segment from the input data to generate an address corresponding to a value of the extracted data segment; step (c) of reading reference data stored in an address generated at step (b) from the first memory; and step (d) of determining whether or not the input data is consistent with the detection condition based on the reference data output from the first memory at step (c).

Preferably, in the above data consistency detection method, step (d) includes the step of determining that the input data is consistent with the detection condition if the reference data read from the first memory indicates “consistency” for all of the plurality of data segments included in the input data.

Preferably, in the above data consistency detection method, step (a) includes the step of storing the reference data in advance in an address generated based on a position of each of the plurality of data segments in the input data and each of the possible values that the data segment can have; and step (b) includes the step of generating an address based on a position of the extracted data segment in the input data and a value of the extracted data segment.

Preferably, in the above data consistency detection method, step (d) includes: step (e) of storing the data which indicates “consistency” as an initial value in a second memory; step (f) of storing the data which indicates “consistency” in the second memory if both the reference data read from the first memory at step (c) and the data stored in the second memory indicate “consistency” and storing the data which indicates “inconsistency” in the second memory if at least one of the reference data read from the first memory at step (c) and the data stored in the second memory indicates “inconsistency”; and step (g) of outputting, as consistency determination information, the data stored in the second memory at step (f) for the last one of the plurality of data segments extracted from the input data at step (b).

Preferably, the above data consistency detection method further comprises step (e) of assigning a predetermined arithmetic operation to each of the plurality of data segments, wherein step (d) includes: step (f) of storing the data which indicates “consistency” as an initial value in a second memory; step (g) of performing an arithmetic operation assigned to a data segment which corresponds to the reference data read from the first memory at step (c) on at least one of the reference data and the output data stored in the second memory to store a result of the arithmetic operation in the second memory; and step (h) of outputting, as consistency determination information, the data stored in the second memory at step (g) for the last one of the plurality of data segments extracted from the input data at step (b).

Preferably, in the above data consistency detection method, the second memory is capable of storing a plurality of arithmetic operation results; and step (g) includes the step of performing an arithmetic operation assigned to a data segment which corresponds to the reference data read from the first memory at step (c) on at least one of the reference data and the plurality of arithmetic operation results stored in the second memory to store a result of the arithmetic operation in the second memory.

### BRIEF DESCRIPTION OF THE DRAWINGS

FIG. 1 shows the data structures of a transport stream packet and a section based on the MPEG system standard.

FIG. 2 is a block diagram showing the structure of a transport packet processing circuit of a digital broadcast receiver.

FIG. 3 is a table showing an example of consistency detection conditions for selecting section data.

FIG. 4 is a block diagram showing the structure of a section data selection circuit.

FIG. 5 is a block diagram showing the structure of a header consistency detection circuit according to embodiment 1.

FIG. 6 is a table showing the field position signal output when respective fields are output.

FIG. 7 is an address map of a pattern memory.

FIG. 8 shows an example wherein reference data is stored in the pattern memory based on the first and second consistency detection conditions shown in FIG. 3.

FIG. 9 shows another example wherein reference data is stored in the pattern memory based on the first and second consistency detection conditions shown in FIG. 3.

FIG. 10 shows an example of input section data.

FIG. 11 shows another example of input section data.

FIG. 12 is a block diagram showing the structure of a header consistency detection circuit according to embodiment 2.

FIG. 13 is a table showing the data segment position signal output when respective data segments are output.

FIG. 14 is an address map of a pattern memory.

FIG. 15 is a table showing an example of consistency detection conditions.

FIG. 16 is a table showing an example of the operation type and operation order which are set for each data segment.

FIG. 17 shows an example of an input section.

FIG. 18 shows another example of an input section.

FIG. 19 is a block diagram showing the structure of a header consistency detection circuit according to embodiment 3.

FIG. 20 is an address map of a pattern memory.

FIG. 21 is an address map of a mask condition memory.

FIG. 22 is an address map of an inversion condition memory.

### DESCRIPTION OF THE PREFERRED EMBODIMENTS

As an embodiment of the present invention, a section data selection circuit (data selection device) for abandoning/selecting various information transmitted using data of a section data format as necessary and a header consistency detection circuit (data consistency detection device) included in the section data selection circuit, which are used in a digital broadcast system compliant with the MPEG system standard, are described.

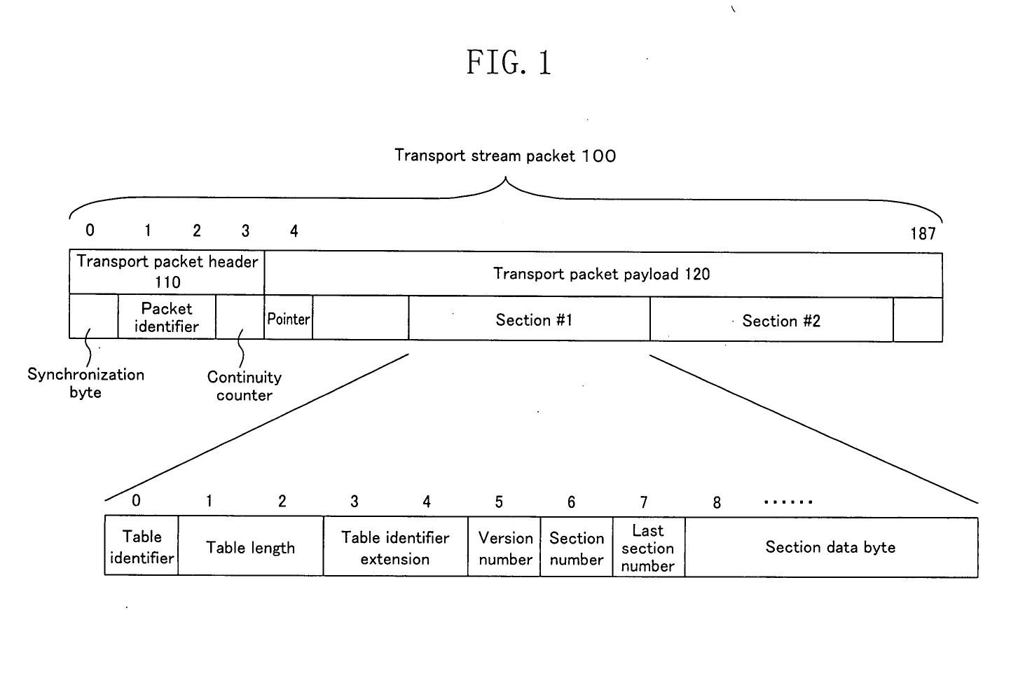

In a digital broadcast, various information, such as video, audio, etc., are transferred in the form of transport streams. In a transport stream, transport stream packets, each of which has a fixed length, are sequentially transferred. FIG. 1 shows the format of a transport stream packet and the format of section data for storing tables of various data in the transport stream packet.

The transport stream packet 100 includes a transport packet header 110 which includes a packet identification number, etc., and a transport packet payload 120 which is a primary part of data to be transferred in the form of a packet. Information of video and audio are contained in the form of a PES packet in the transport packet payload 120. On the other hand, various information associated with a broadcast or program (program table, key information for encryption, etc.) are contained in the form of a section in the transport packet payload 120. In FIG. 1, the transport stream packet 100 contains various information in the form of sections. A single transport stream packet 100 can contain a plurality of sections (section #1, section #2, . . . ). FIG. 1 further shows a data format of the section. The section includes information which represents the type of data, such as a table identifier, a table length, a data identifier extension, a version number, a section number, a last section number, and the like, and a main part of the data. It can be determined from the table identifier, or the like, whether or not the data of the section is to be received.

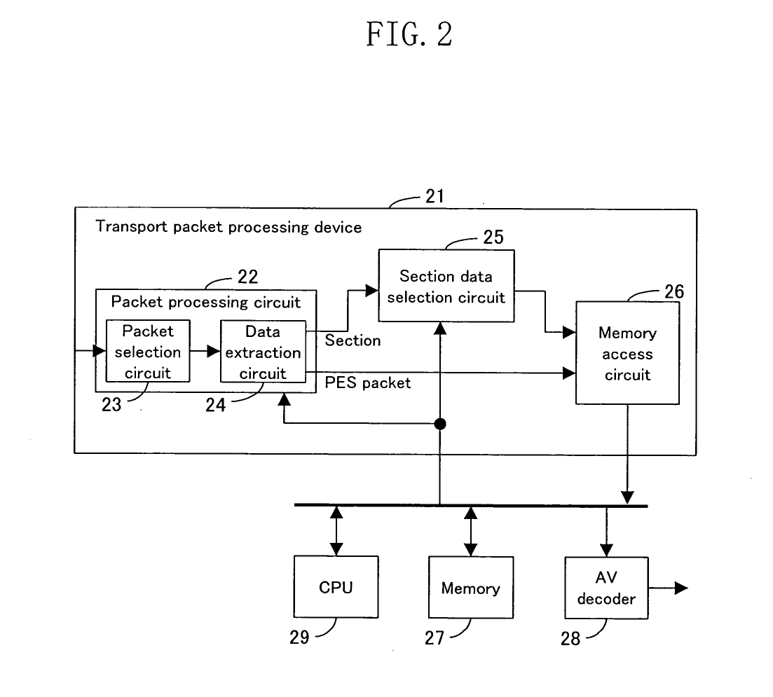

FIG. 2 shows a general structure of a transport packet processing device 21 which is a component of a digital broadcast receiver. A transport stream input to the transport packet processing device 21 is first processed at a packet processing circuit 22. The transport stream packet 100 is first subjected to selection on a transport-stream-packet by transport-stream-packet basis at a packet selection circuit 23. Then, at a data extraction circuit 24, data is extracted from the transport packet payload 120. Herein, information of video and audio are extracted in the form of PES packets and written in a memory 27 by a memory access circuit 26. This information is extracted from the memory 27 to an AV decoder 28, and pictures/sounds are reproduced and displayed/emitted. On the other hand, various information of a program or broadcast are extracted as a section from the transport packet payload 120. The section is input to a section data selection circuit 25 and determined as to whether or not it is necessary here. The selected section is written in the memory 27 by the memory access circuit 26. Thereafter, a CPU 29 reads the section from the memory 27 and extracts various information contained in the section for use in controlling the operation of the receiver.

Various information transferred in the form of sections are very important information for the receiver, and therefore, the same information are repeatedly broadcast such that they are received without fail. However, once such information has been received, it is not necessary to receive the same information any more. Thus, whether or not the section is necessary is determined according to the status of the receiver. If it is possible to abandon unnecessary information, the amount of information processed by the CPU can be reduced accordingly. As a result, it is helpful in improving the process capacity of the receiver.

### Embodiment 1

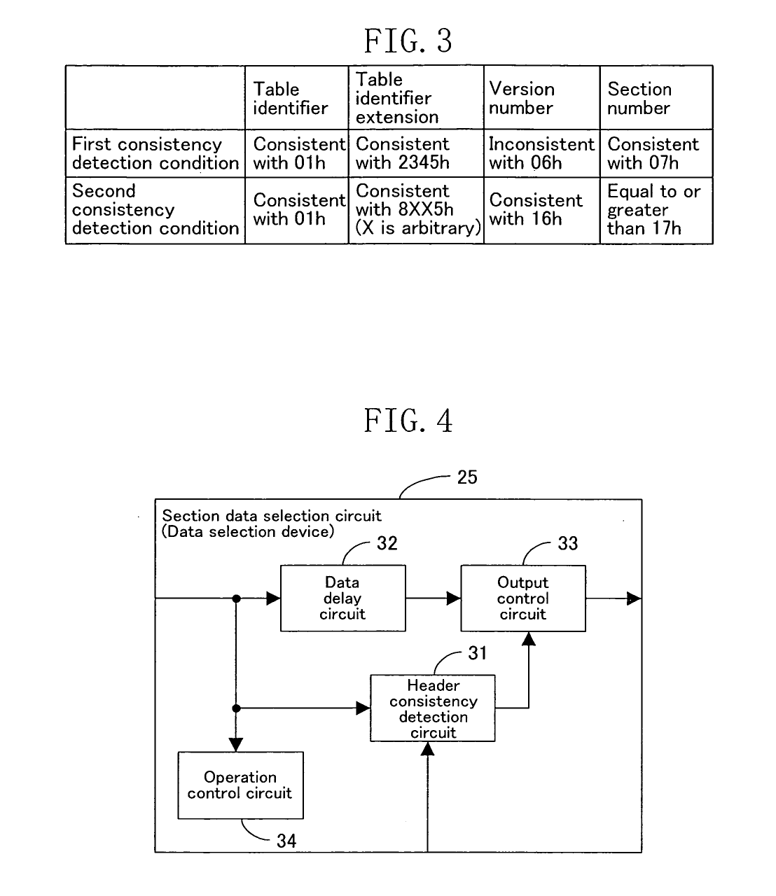

A section data selection circuit of embodiment 1 is described with an example of selection of section data in four fields of a section: an table identifier, a table identifier extension, a version number and a section number. Herein, selection of the section shown in FIG. 3 is described.

FIG. 4 shows the structure of a section data selection circuit (data selection device) 25. Section data input to the section data selection circuit 25 is input to a data delay circuit 32, a header consistency detection circuit 31 and an operation control circuit 34. In the header consistency detection circuit 31, condition consistency between a header of the input section and consistency detection candidate data shown in FIG. 3 is checked. If the section header is consistent with at least one of the two types of consistency detection conditions of FIG. 3, the header consistency detection circuit 31 outputs a consistency determination signal which indicates “consistency” to an output control circuit 33. The data delay circuit 32 delays the section data input thereto till the header consistency detection circuit 31 determines whether or not the section header is consistent with the conditions. The section data output from the data delay circuit 32 is input to the output control circuit 33. The output control circuit 33 only outputs section data supplied from the data delay circuit 32 for which the consistency determination signal received from the header consistency detection circuit 31 indicates “consistency”. In this way, the section data selection circuit 25 selects and outputs section data which is consistent with at least one of the plurality of consistency detection candidate data (consistency detection conditions). The operation control circuit 34 controls the operation timings of the components of the section data selection circuit 25 as described above according to the section data sequentially input thereto.

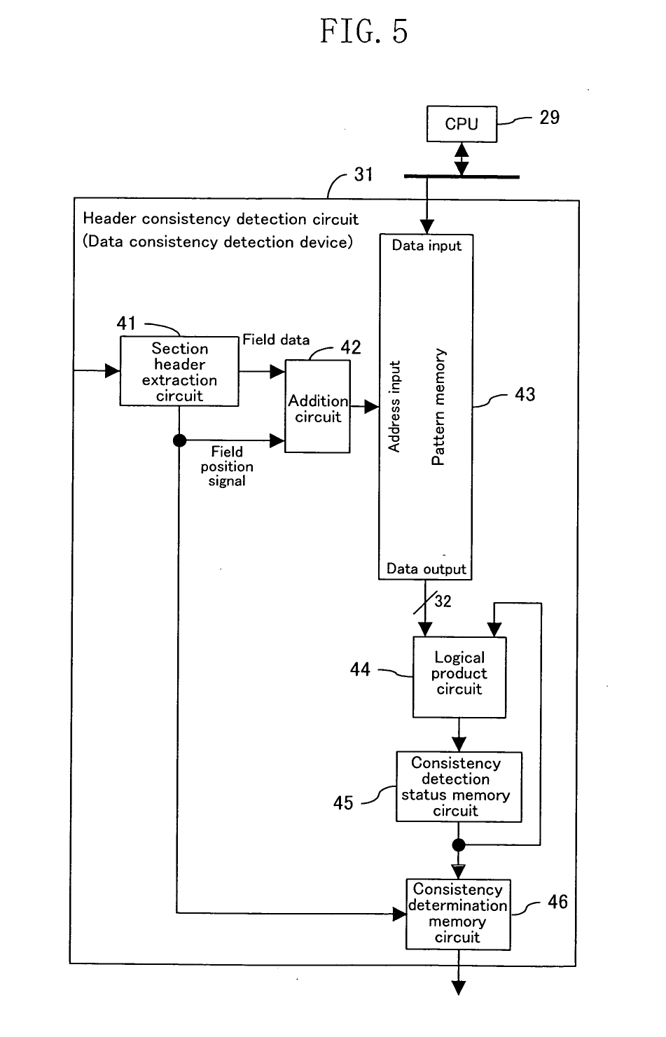

FIG. 5 shows the structure of the above-described header consistency detection circuit (data consistency detection device) 31. The header consistency detection circuit 31 includes a section header extraction circuit 41, an addition circuit 42, a pattern memory 43, a logical product circuit 44, a consistency detection status memory circuit 45, and a consistency determination memory circuit 46.

The section header extraction circuit 41 extracts respective field data which constitute a section header from a section input thereto and sequentially outputs the extracted field data. The section header extraction circuit 41 also outputs a field position signal, which indicates the position of this field data in the section header, while outputting the extracted field data.

The addition circuit 42 adds together the field data and the field position signal, which are output from the section header extraction circuit 41, to output an addition result to the pattern memory 43.

The pattern memory 43 contains in advance, in an address corresponding to each of possible values that each field of the section header can have, reference data indicating that the possible value is consistent with the consistency detection condition (FIG. 3) (“consistency”) or reference data indicating that the possible value is inconsistent with the consistency detection condition (FIG. 3) (“inconsistency”) based on the consistency detection conditions (FIG. 3) under the control of the CPU 29. An example of storage of the reference data in the pattern memory 43 will be described later. A value is set to each bit of the reference data of a plurality of bits (32 bits in embodiment 1) which is stored in each address of the pattern memory 43 based on an independent consistency detection condition. In the case where a read operation is performed in the pattern memory 43 using an addition result of the field data and the field position signal, which are input from the addition circuit 42, as an address, reference data which indicates whether or not this field data is consistent with the consistency detection conditions (FIG. 3) is output.

The consistency detection status memory circuit 45 is a 32-bit memory circuit, each bit storing the status of a consistency detection process. The consistency detection status memory circuit 45 initializes the values of all of the bits to “1” which indicates “consistency” at every start of the section. Thereafter, every time comparison of each field data is executed, the consistency detection status memory circuit 45 stores the output of the logical product circuit 44 and outputs the stored value.

The logical product circuit 44 outputs “consistency” for a bit(s) where both the output of the pattern memory 43 and the output signal from the consistency detection status memory circuit 45 indicate “consistency” but outputs “inconsistency” for the other bits. The output of the logical product circuit 44 is stored in the consistency detection status memory circuit 45.

After reference to the pattern memory 43 has been completed for all of the fields of the section header of a certain section, if at least one bit of the output of the consistency detection status memory circuit 45 indicates “consistency”, the consistency determination memory circuit 46 stores and outputs “consistency”. If otherwise, the consistency determination memory circuit 46 stores and outputs “inconsistency”. In this way, a consistency determination result between the section header and the consistency detection conditions is stored in and output from the consistency determination memory circuit 46.

The function and operation of the header consistency detection circuit 31 is described more specifically.

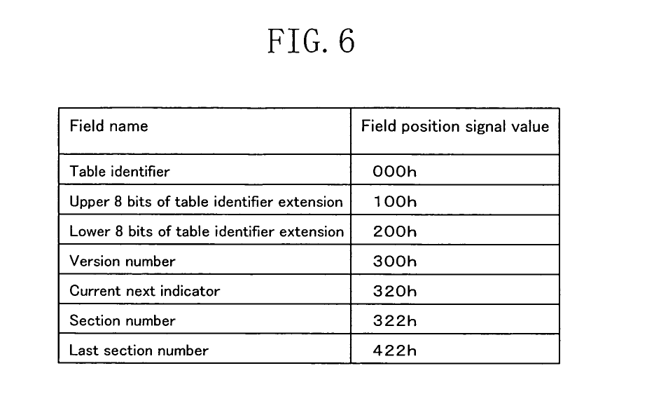

The section header extraction circuit 41 extracts the fields which constitute a section header (table identifier, table identifier extension, version number, current next indicator, section number, last section number) and outputs the extracted fields. It should be noted that in embodiment 1 the table identifier extension is divided into the higher 8-bit part and the lower 8-bit part before being output. FIG. 6 shows the field position signal output when respective fields are output.

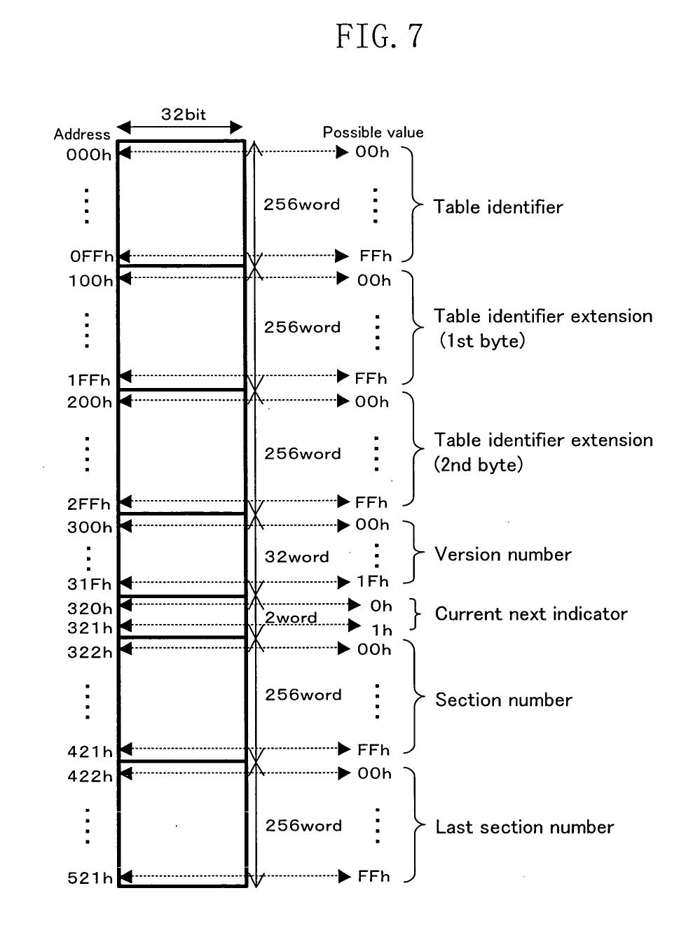

FIG. 7 shows an address map of the pattern memory 43. The pattern memory 43 is a memory of 1314 words. As shown in FIG. 7, addresses 000 to 0FFh correspond to the possible values that the table identifier can have, 00 to FFh; addresses 100 to 1FFh correspond to the possible values that the higher 8 bits of the table identifier extension can have, 00 to FFh; addresses 200 to 2FFh correspond to the possible values that the lower 8 bits of the table identifier extension can have, 00 to FFh; addresses 300 to 31Fh correspond to the possible values that the version number can have, 00 to 1Fh; addresses 320 to 321h correspond to the possible values that the current next indicator can have, 0 to 1h; addresses 322 to 421h correspond to the possible values that the section number can have, 00 to FFh; and addresses 422 to 521h correspond to the possible values that the last section number can have, 00 to FFh. Each address can store reference data of 32 bits. Each bit of the reference data corresponds to an independent consistency detection condition. That is, in embodiment 1, consistency detection with 32 types of consistency detection conditions is possible. In embodiment 1, an example of two types of consistency detection conditions (first consistency detection condition and second consistency detection condition) shown in FIG. 3 is described.

Reference data is stored in the pattern memory 43 based on the first and second consistency detection conditions of FIG. 3 as described below.

It is assumed herein that the reference data of addresses 000h to 521h of the pattern memory 43 are all initialized to. 0 which indicates “inconsistency”. The first consistency detection condition corresponds to bit position 0 of the 32-bit reference data of the pattern memory 43.

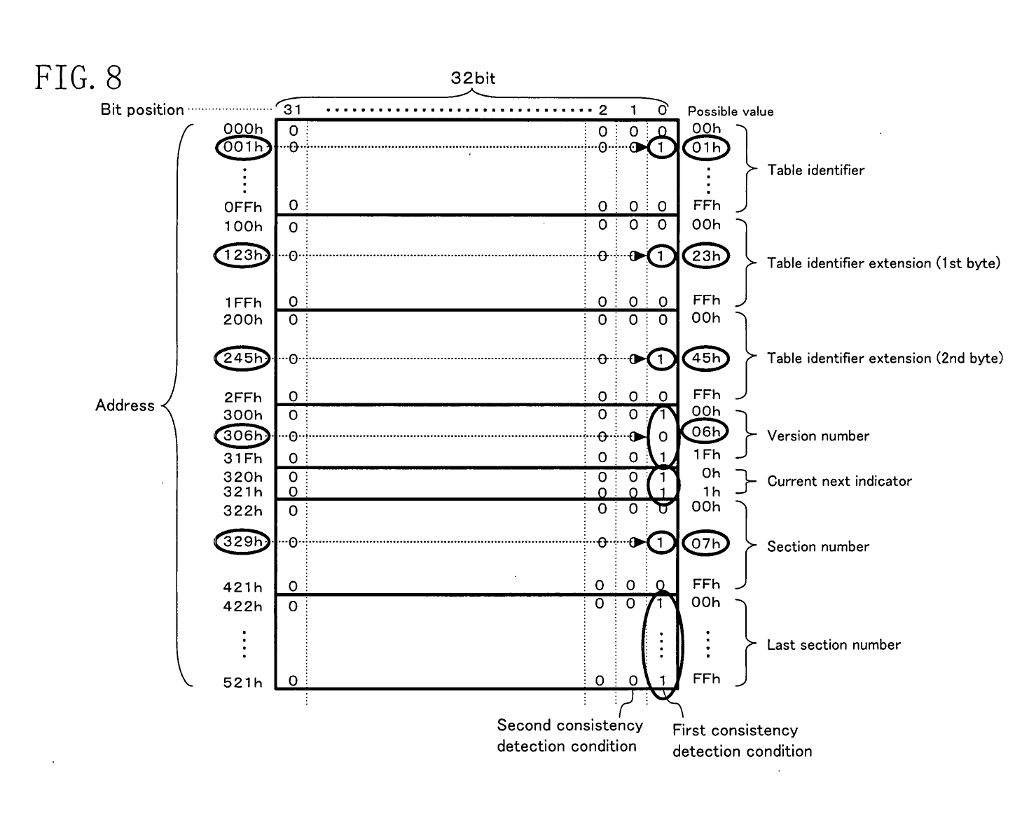

Since as for the table identifier it is necessary to detect consistency with 01h, “1” which indicates “consistency” is stored at bit position 0 of address 001h which is obtained by adding together 01h and field position signal 000h corresponding to the table identifier as shown in FIG. 8.

Since as for the upper 8 bits of the table identifier extension it is necessary to detect consistency with 23h, “1” is stored at bit position 0 of address 123h which is obtained by adding together 23h and 100h (field position signal value which indicates the upper 8 bits of the table identifier extension) as shown in FIG. 8.

Likewise, as for the lower 8 bits of the table identifier extension, “1” is stored at bit position 0 of address 200h+45h=245h as shown in FIG. 8.

Since as for the version number it is necessary to detect inconsistency with “06h”, the value of bit position 0 of address 306h (=300h (value of field position signal corresponding to version number)+06h) remains “0”, while “1” is stored at bit position 0 of the addresses corresponding to the values that the version number can have except for 06h, i.e., addresses 300h to 305h and 307h to 31h. Detection of inconsistency with 06h is equivalent to detection of consistency with all the data other than 06h.

As for the section number, “1” is stored at bit position 0 of address 322h+07h=329h as shown in FIG. 8.

In this example (first consistency detection condition), as for the current next indicator and last section number which are not to be compared, bit position 0 of addresses 320 to 321h and 422 to 521h of the pattern memory 43 is set to “1” as shown in FIG. 8, whereby the result of “consistency” is output no matter what field data is input.

It is assumed that the second consistency detection condition corresponds to bit position 1 of reference data of the pattern memory 43.

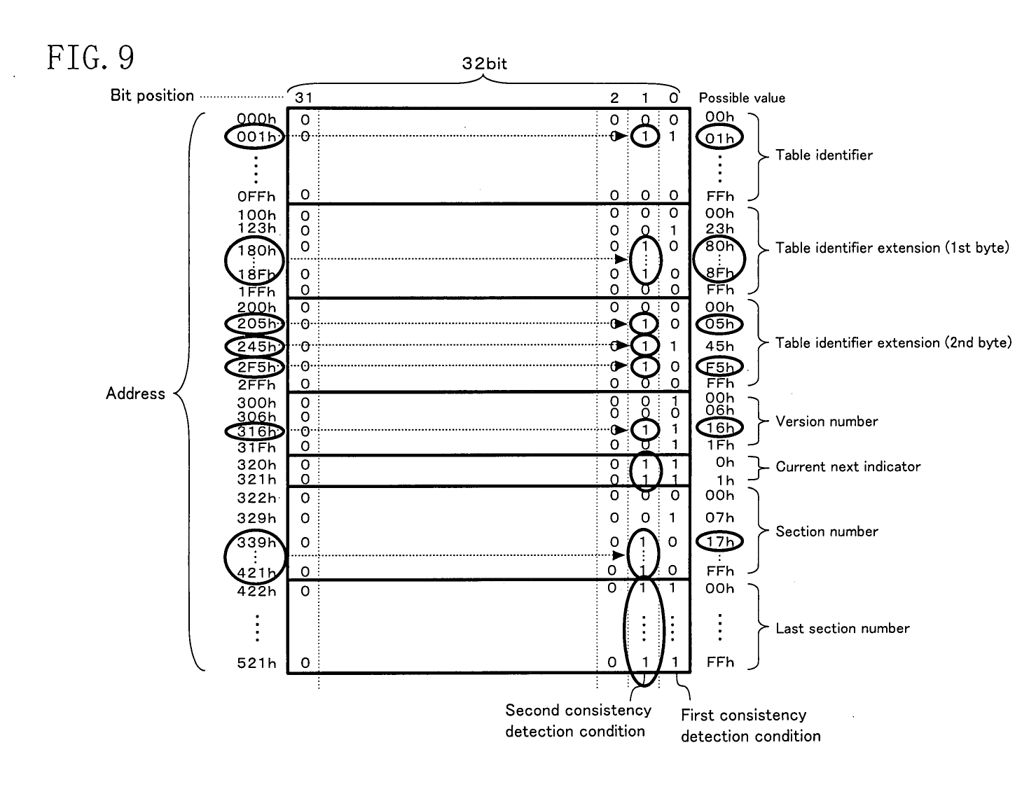

Since as for the table identifier it is necessary to detect consistency with 01h, bit position 1 of address 01h+000h=001h is set to “1” as shown in FIG. 9.

Since as for the upper 8 bits of the table identifier extension it is necessary to detect consistency with 8Xh (X is arbitrary), “1” is set at bit position 1 of address 01h+000h=001h, i.e., addresses 180h to 18Fh, as shown in FIG. 9.

Likewise, as for the lower 8 bits of the table identifier extension. “1” is stored at bit position 1 of address 200h+X5h=2X5h (X is arbitrary), i.e., addresses 205h, 215h, 225h, . . . 2F5h as shown in FIG. 9.

Since as for the version number it is necessary to detect consistency with 16h, “1” is set at bit position 1 of address 300h+16h=316h as shown in FIG. 9.

Since as for the section number it is necessary to detect consistency with a value equal to or greater than 17h, “1” is stored at bit position 1 of address 322h+17h=339h and subsequent addresses among addresses 322h to 421h as shown in FIG. 9.

In this example (second consistency detection condition), as for the current next indicator and last section number which are not to be compared, bit position 0 of addresses 320 to 321h and 422 to 521h of the pattern memory 43 is set to “1” as shown in FIG. 9, whereby the result of “consistency” is output no matter what field data is input.

As described above, the reference data is stored in the pattern memory 43 based on the first and second consistency detection conditions of FIG. 3.

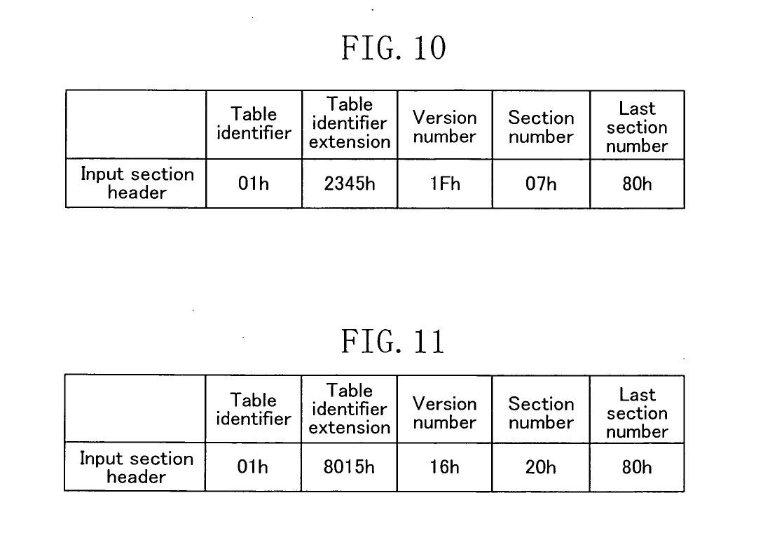

Now, consider a case where a section having a header shown in FIG. 10 is input. This section is consistent with the first consistency detection condition shown in FIG. 3.

First, the section header extraction circuit 41 extracts the table identifier (=01h), which is the first field, from the input section. At the same time, “000h” is output from the section header extraction circuit 41 as the field position signal. These two outputs are added together at the addition circuit 42, and “001h” is input to the pattern memory 43 as an address. Reference data “00000003h” of 32 bits, which is stored in address 001h (only values of bit position 0 and bit position 1 are “1” (“1” denotes “consistency”)), is read from the pattern memory 43 and input to the logical product circuit 44. On the other hand, immediately after the start of the section, all of the bits are initialized to “1” (“1” denotes “consistency”) in the consistency detection status memory circuit 45, i.e., “FFFFFFFFh” is stored in the consistency detection status memory circuit 45, and this value is input to the logical product circuit 44. The logical product circuit 44 performs a logical product operation on the above two pieces of input data on a bit-by-bit basis to output operation result 00000003h. Operation result 00000003h is stored in the consistency detection status memory circuit 45 and output from the consistency detection status memory circuit 45. Value 00000003h stored in the consistency detection status memory circuit 45 means that the table identifier, which is the first field of the input section data, is consistent with the two consistency detection conditions (first and second consistency detection conditions) set at bit position 0 and bit position 1, respectively, of the pattern memory 43.

Then, the section header extraction circuit 41 extracts the upper 8 bits of the table identifier extension (=23h), which is the second field, from the input section. At the same time, “100h” is output from the section header extraction circuit 41 as the field position signal, and addition result 123h is input to the pattern memory 43 as an address. Reference data “00000001h” of 32 bits, which is stored in address 123h (only the value of bit position 0 is “1”), is read from the pattern memory 43 and input to the logical product circuit 44. The logical product circuit 44 performs a logical product operation of “00000001h” output from the pattern memory 43 and “00000003h” output from the consistency detection status memory circuit 45 to output operation result 00000001h. The consistency detection status memory circuit 45 stores value 00000001h. This value means that a part of the input section data up to the second field (the upper 8 bits of the table identifier extension) is consistent only with the first consistency detection condition set at bit position 0 of the pattern memory 43.

Then, the section header extraction circuit 41 extracts the lower 8 bits of the table identifier extension (=45h), which is the third field, from the input section. At the same time, “200h” is output from the section header extraction circuit 41 as the field position signal, and addition result 245h is input to the pattern memory 43 as an address. Reference data “00000003h” of 32 bits which is stored in address 245h (the values of bit position 0 and bit position 1 are “1”) is read from the pattern memory 43 and input to the logical product circuit 44. Value “1” is set at bit position 1 of address 2X5h (X is arbitrary) of the pattern memory 43 such that the determination result of consistency with “X5h (X is arbitrary)” indicates “consistency”. That is, “1” is also stored at address 245h. The logical product circuit 44 performs a logical product operation of “00000003h” output from the pattern memory 43 and “00000001h” output from the consistency detection status memory circuit 45 to output operation result 00000001h. The consistency detection status memory circuit 45 stores this value 00000001h. This value means that a part of the input section data up to the third field (the lower 8 bits of the table identifier extension) is consistent only with the first consistency detection condition set at bit position 0 of the pattern memory 43. The output of the pattern memory 43 is “00000003h”, which means consistency with the two conditions at bit position 0 and bit position 1 (first and second consistency detection conditions). The consistency detection status memory circuit 45 already has stored “inconsistency” as the consistency detection state up to the second field except for the condition at bit position 0 (first consistency detection condition). Therefore, in the third field, the condition consistent at bit position 1 (second consistency detection condition) is also stored as “inconsistency” in the consistency detection status memory circuit 45.

Then, the section header extraction circuit 41 extracts the version number 1Fh, which is the fourth field, from the input section. The version number is a 5-bit value. At the same time, “300h” is output from the section header extraction circuit 41 as the field position signal, and addition result 31Fh is input to the pattern memory 43 as an address. At bit position “0” of addresses 300h to 31Fh (except for address 306h) of the pattern memory 43, “1” is set such that inconsistency with 06h, i.e., consistency with all the values other than 06h, is detected. Value “00000001h” (bit position 0 is “1”) is read from address 31Fh and input to the logical product circuit 44. The logical product circuit 44 performs a logical product operation of “00000001h” output from the pattern memory 43 and “00000001h” output from the consistency detection status memory circuit 45 to output operation result 00000001h. The consistency detection status memory circuit 45 stores this value 00000001h. This value means that a part of the input section data up to the fourth field (version number) is consistent only with the first consistency detection condition set at bit position 0 of the pattern memory 43.

Then, the section header extraction circuit 41 extracts the current next indicator, which is the fifth field, from the input section. The current next indicator is a 1-bit value. At the same time, “320h” is output from the section header extraction circuit 41 as the field position signal. Since “1” is stored at bit position 0 of addresses 320h and 321h of the pattern memory 43, “00000001h” is output from the pattern memory 43 and input to the logical product circuit 44 irrespective of the value of the input current next indicator. The logical product circuit 44 performs a logical product operation of “00000001h” output from the pattern memory 43 and “00000001h” output from the consistency detection status memory circuit 45 to output operation result 00000001h. The consistency detection status memory circuit 45 stores this value 00000001h. This value means that a part of the input section data up to the fifth field (current next indicator) is consistent only with the first consistency detection condition set at bit position 0 of the pattern memory 43.

Then, the section header extraction circuit 41 extracts the section number 07h, which is the sixth field, from the input section. At the same time, “322h” is output from the section header extraction circuit 41 as the field position signal. Addition result of these values, 329h, is input to the pattern memory 43 as an address. Since “1” is stored at bit position 0 of address 329h, “00000001h” is output from the pattern memory 43 and input to the logical product circuit 44. The logical product circuit 44 performs a logical product operation of “00000001h” output from the pattern memory 43 and “00000001h” output from the consistency detection status memory circuit 45 to output operation result 00000001h. The consistency detection status memory circuit 45 stores this value 00000001h. This value means that a part of the input section data up to the sixth field (section number) is consistent only with the first consistency detection condition set at bit position 0 of the pattern memory 43.

Then, the section header extraction circuit 41 extracts the last section number (=80h), which is the seventh field, from the input section. At the same time, “422h” is output from the section header extraction circuit 41 as the field position signal.

Since “1” is stored at bit position 0 of addresses 422h to 521h of the pattern memory 43, “00000001h” is output from the pattern memory 43 and input to the logical product circuit 44 irrespective of the value of the input last section number. The logical product circuit 44 performs a logical product operation of “00000001h” output from the pattern memory 43 and “00000001h” output from the consistency detection status memory circuit 45 to output operation result 00000001h. The consistency detection status memory circuit 45 stores this value 00000001h. This value means that the input section data is consistent with the first consistency detection condition set at bit position 0 of the pattern memory 43 at the time when consistency detection for a part of the input section data up to the seventh field (last section number), i.e., all of the fields of the input section data which are to be subjected to consistency detection, is completed.

Since consistency detection between the input section data and the consistency detection conditions has been completed, “00000001h” stored in the consistency detection status memory circuit 45 is input to the consistency determination memory circuit 46. Since the input is not 0, the consistency determination memory circuit 46 determines that the input section data is consistent with the first consistency detection condition to output “consistency” as the consistency determination result.

As described above, it is determined that the input section is consistent with the consistency detection condition. Accordingly, the consistency determination memory circuit 46 outputs “consistency”, and the header consistency detection circuit 31 also outputs “consistency”.

On the other hand, if each field of the input section data is not consistent with the consistency detection condition, the pattern memory 43 outputs “0” which denotes “inconsistency”. Accordingly, the output of the logical product circuit 44 results in “0”, which is stored in the consistency detection status memory circuit 45. Thus, even if subsequent conditions are consistent, the output of the logical product circuit 44 is “0”, and it is determined to be inconsistent with the consistency detection condition. In this way, if “inconsistency” is detected in a field in the middle of the consistency detection process, the subsequent status of the consistency detection status memory circuit 45 is “inconsistency”, and “inconsistency” is stored in and output from the consistency determination memory circuit 46.

Next, consider a case where a section having a header shown in FIG. 11 is input.

Being processed in the same manner as that described in the above example of FIG. 10, the input section data having the input section header shown in FIG. 11 is consistent with the second consistency detection condition (see FIG. 3) set at bit position 1 of the pattern memory 43 as to the table identifier, the table identifier extension, the version number, the current next indicator and the last section number. Herein, the section number of FIG. 11 is described in detail.

Section number 20h is extracted by the section header extraction circuit 41 and input to the addition circuit 42. At the same time, “322h” is output from the section header extraction circuit 41 as the field position signal, and addition result 342h is input to the pattern memory 43 as an address. Among addresses 322h to 421h of the pattern memory 43, address 339h and subsequent addresses store “1” at bit position 1 such that consistency with input data equal to or greater than 17h can be detected. Thus, “00000002h” (bit position 1 is “1”) is read from address 342h and input to the logical product circuit 44. On the other hand, since fields of the input section header prior to the section number are consistent with the condition at bit position 1 (second consistency detection condition), the consistency detection status memory circuit 45 stores and outputs “00000002h”. The logical product circuit 44 performs a logical product operation of “00000002h” output from the pattern memory 43 and “00000002h” output from the consistency detection status memory circuit 45 to output operation result 00000002h. The consistency detection status memory circuit 45 stores this value 00000002h.

Consistency is also detected as to the last section number subsequently input.

As described above, it is determined that the input section is consistent with the second consistency detection condition. Accordingly, the consistency determination memory circuit 46 outputs “consistency” as the consistency determination result, and the header consistency detection circuit 31 also outputs “consistency”.

When “consistency” is detected by the header consistency detection circuit 31, the output control circuit 33 of the section data selection circuit 25 outputs the input section data delayed by the data delay circuit 32.

As described above, in the section data selection circuit 25 of embodiment 1, 32 types of consistency detection conditions for detecting consistency with the section header can be set at the maximum, and a section having a section header which is consistent with any of the consistency detection conditions can be selected and output.

Since comparison with the consistency detection conditions can be completed through a single read operation of reading the fields that constitute a section header to the pattern memory 43, the access bandwidth of a memory required by the header consistency detection circuit 31 is suppressed to a small width.

For example, even when selection of the section input at 12.5 Mbytes/sec is performed for the 32 types of conditions, only the memory access bandwidth of 12.5 M times×32 bits=50 Mbytes/sec is required. Thus, the requested performance is greatly reduced as compared with 800 Mbytes/sec that is required in the conventional technique.

Since the reference data which indicates consistency/inconsistency with the consistency detection conditions for all of data values is stored in the pattern memory 43 in advance, not only detection of consistency with condition data but also detection of inconsistency, comparison of largeness, suppression of comparison for a part of field data, etc., can be achieved. As a result, highly flexible detection conditions can be set.

In embodiment 1, 32 types of consistency detection conditions can be set in the pattern memory 43, but the present invention is not limited thereto. According to the present invention, any number of conditions can be employed by changing the number of bits dealt with in the pattern memory 43, the logical product circuit 44, the consistency detection status memory circuit 45 and the consistency determination memory circuit 46 according to the number of consistency detection conditions.

In the above description, the header consistency detection circuit 31 of embodiment 1 performs consistency detection for all of the fields of a section header, i.e., the leading fields up to the 8th byte of the section data, but the fields to be subjected to consistency detection are not limited thereto. Consistency detection can be performed on data of any size.

In the above description, only a result that indicates consistency or not is output as the consistency determination result from the consistency determination memory circuit 46 of embodiment 1. However, in addition, an input from the consistency detection status memory circuit 45 which represents a condition with which consistency is detected may be stored, and this information may be output. Thus, the section data selection circuit 25 is capable of not only determining consistency with a consistency detection condition to determine whether or not section data is allowed to be output but also outputting information indicating a condition with which consistency is detected.

In the above description of embodiment 1, the pattern memory 43 is a memory incorporated in the header consistency detection circuit 31, but the present invention is not limited thereto. The pattern memory 43 may be provided outside the header consistency detection circuit 31. For example, the pattern memory 43 may be realized by a main storage memory of the CPU 29. As described above, only a memory access bandwidth of 50 Mbytes/sec is used for executing selection of a section input at 12.5 Mbytes/sec with 32 types of conditions. The main storage memory of the CPU 29 generally has an access bandwidth of several hundreds of megabytes/sec. Thus, an embodiment wherein a header consistency detection circuit uses a 50 Mbytes/sec portion of the access bandwidth is practically realizable. In the case where the pattern memory 43 is realized by an external large-capacity memory, the increase in the capacity of the pattern memory 43, which is required when increasing the number of fields to be subjected to consistency detection or the number of consistency detection conditions, is readily achieved.

In the above example described in embodiment 1, extraction of a section header and addition of field data and the field position signal to make an address to the pattern memory 43 are realized by a circuit, but the present invention is not limited thereto. Extraction of a section header from section data, counting of the field position, and addition of the field position information in the form of the field position signal and the field data can be entirely or partially realized by software. In embodiment 1, extraction of the field data is data processing of 12.5 Mbytes/sec and therefore can be realized by software.

In the above-described example of embodiment 1, the logical product circuit 44, the consistency detection status memory circuit 45 and the consistency determination memory circuit 46 are realized by circuits, but the present invention is not limited thereto. These components may be realized by software processing.

In a possible example, the pattern memory 43 is realized as a main storage memory of the CPU 29 as described above, and the other processing of the header consistency detection circuit 31 is realized by software. That is, the header consistency detection circuit 31 described in embodiment 1 is partially or entirely realized by software.

### Embodiment 2

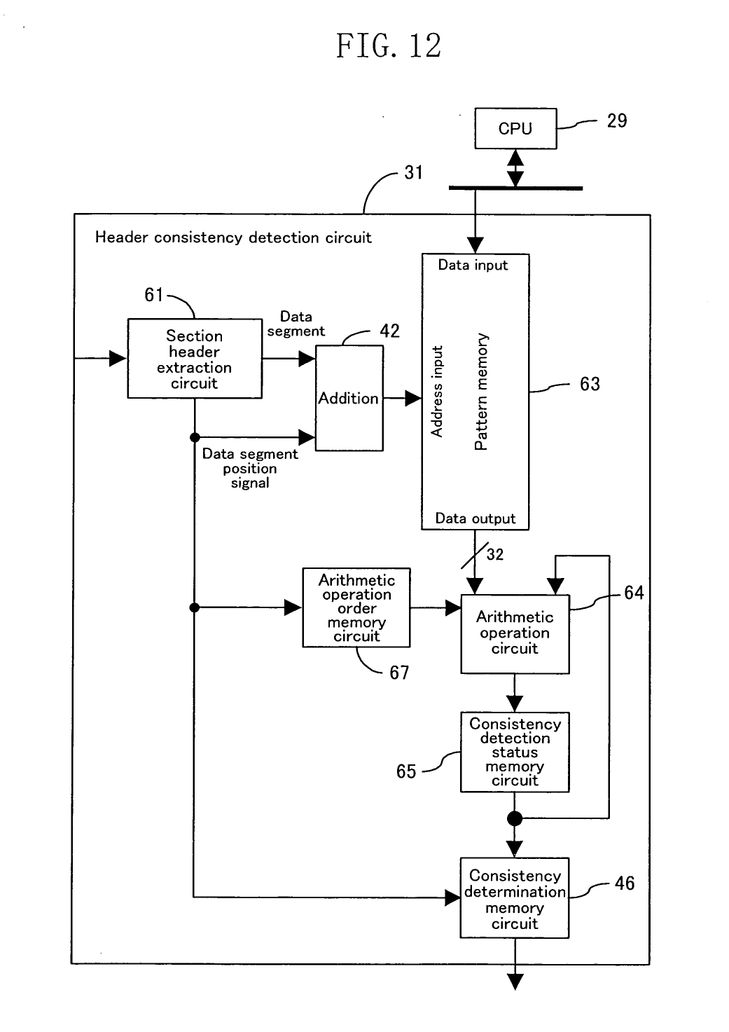

FIG. 12 shows a structure of a header consistency detection circuit according to embodiment 2 of the present invention. The header consistency detection circuit 31 includes a section header extraction circuit 61, an addition circuit 42, a pattern memory 63, an arithmetic operation circuit 64, a consistency detection status memory circuit 65, a consistency determination memory circuit 46, and an arithmetic operation order memory circuit 67.

The section header extraction circuit 61 extracts data which constitutes a section header from a section input thereto in the form of data segments on a 4-bit by 4-bit basis from the leading bit and sequentially outputs the extracted data segments. The section header extraction circuit 61 also outputs a data segment position signal, which indicates the position of this data segment in the section header, while outputting the extracted data segment.

The addition circuit 42 adds together the data segment and the data segment position signal, which are output from the section header extraction circuit 61, to output an addition result to the pattern memory 63.

The pattern memory 63 contains in advance, in an address corresponding to each of possible values that each data segment of the section header can have, reference data indicating that the possible value is consistent with the consistency detection condition (“consistency”) or reference data indicating that the possible value is inconsistent with the consistency detection condition (“inconsistency”) under the control of the CPU 29 as in embodiment 1. In the case where the addition result of the data segment and the data segment position signal, which has been input from the addition circuit 42, is read as an address from the pattern memory 63, the reference data indicating whether or not this data segment is consistent with a consistency detection condition is output.

The consistency detection status memory circuit 65 is capable of storing a plurality of words of 32-bit information. Each bit of each word stores the status of a consistency detection process. At every start of the section, the consistency detection status memory circuit 65 is initialized to a state where nothing is stored. Thereafter, the consistency detection status memory circuit 65 stores the arithmetic operation result of the arithmetic operation circuit 64 every time comparison of each field data is executed.

The arithmetic operation circuit 64 receives the reference data from the pattern memory 63 and reads the value stored in the consistency detection status memory circuit 65 to perform an arithmetic operation on these data according to an instruction from the arithmetic operation order memory circuit 67. The arithmetic operation circuit 64 outputs the result of the arithmetic operation to the consistency detection status memory circuit 65.

The arithmetic operation order memory circuit 67 stores the type of arithmetic operation (program) to be performed in the arithmetic operation circuit 64, which correspond to the data segments extracted by the section header extraction circuit 61. It is possible to assign one or more types of arithmetic operations and an arithmetic operation order to each data segment.

After reference to the pattern memory 63 has been completed for all of the fields of the section header of a certain section, the consistency determination memory circuit 46 reads the data stored in the consistency detection status memory circuit 65. If at least one bit indicates “consistency”, the consistency determination memory circuit 46 stores and outputs “consistency”. If otherwise, the consistency determination memory circuit 46 stores and outputs “inconsistency”.

In this way, a consistency determination result between a section header and the consistency detection conditions is stored in and output from the consistency determination memory circuit 46.

The function and operation of the header consistency detection circuit 31 is described more specifically.

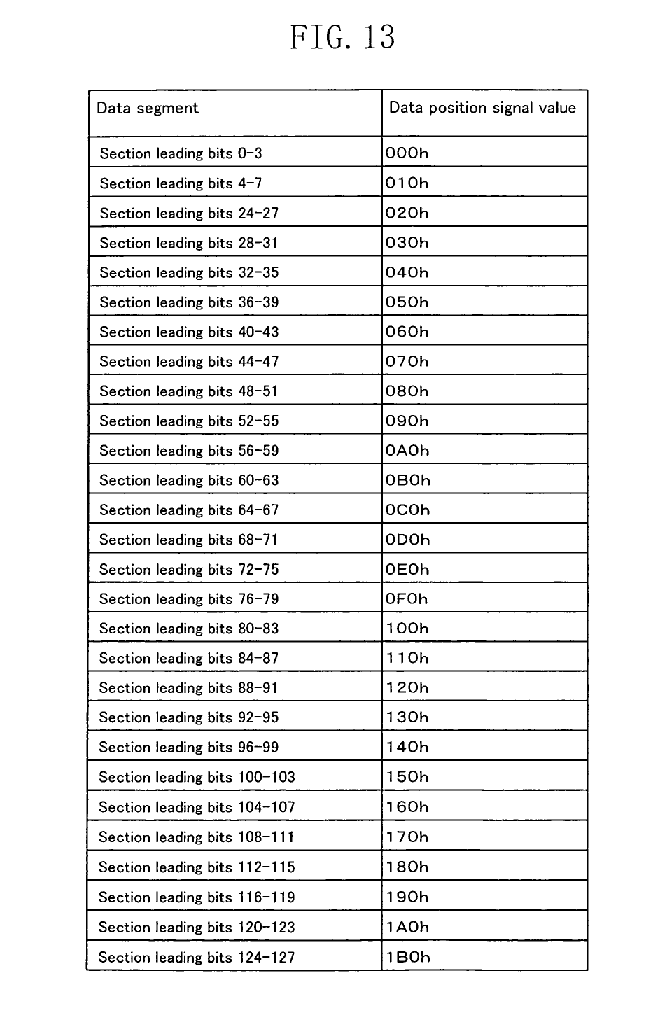

The section header extraction circuit 61 extracts data segments from a data sequence which constitute a section header on a 4-bit by 4-bit basis from the head of the data sequence. For example, two 4-bit data segments at the head of the section correspond to the table identifier. FIG. 13 shows the field position signal output when respective data segments are output.

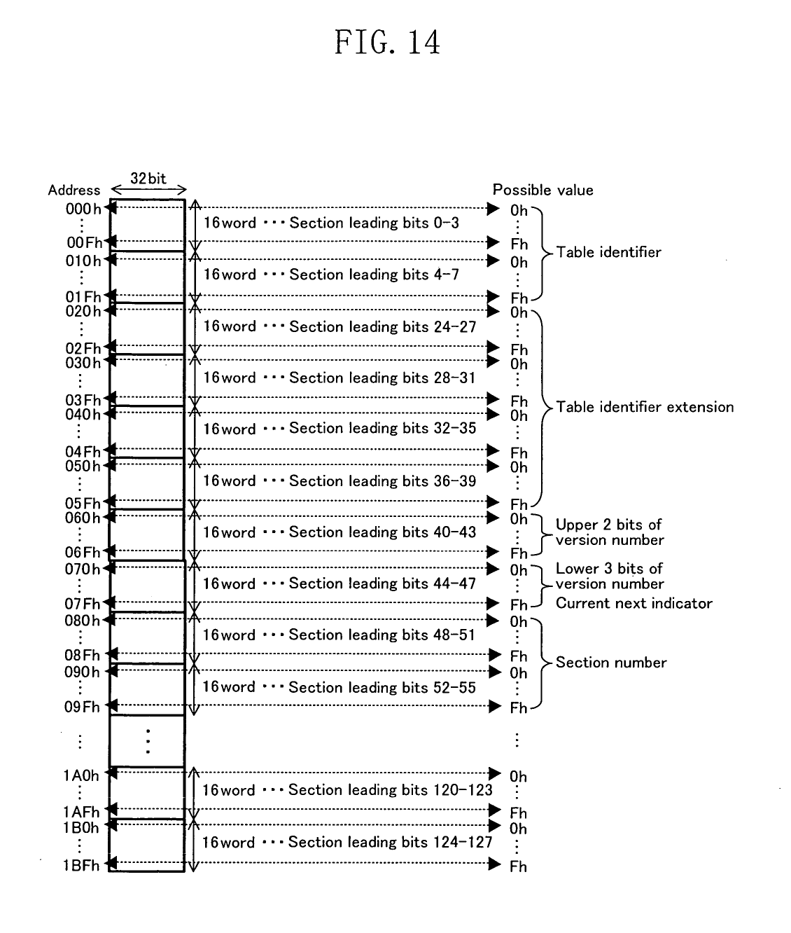

FIG. 14 shows an address map of the pattern memory 63. The pattern memory 63 is a memory of 448 words. As shown in FIG. 14, addresses 000 to 0FFh correspond to the possible values 0 to Fh that the data segment of the 0th to 3rd bits of the section can have, and addresses 010 to 01F correspond to the possible values 0 to Fh that the data segment of the 4th to 7th bits of the section can have. Subsequently, the possible values that each data segment except for the table length field of the section can have correspond to the addresses up to address 1BF. Each address can store the reference data of 32 bits. Each bit of the reference data corresponds to an independent consistency detection condition. That is, according to embodiment 2, consistency detection with the 32 types of consistency detection conditions is possible.

In embodiment 2, selection of a section which satisfies the following conditions is considered:
Table identifier is consistent with 27h;
Version number is inconsistent with 15h; and
Section number is equal to or greater than A5h.

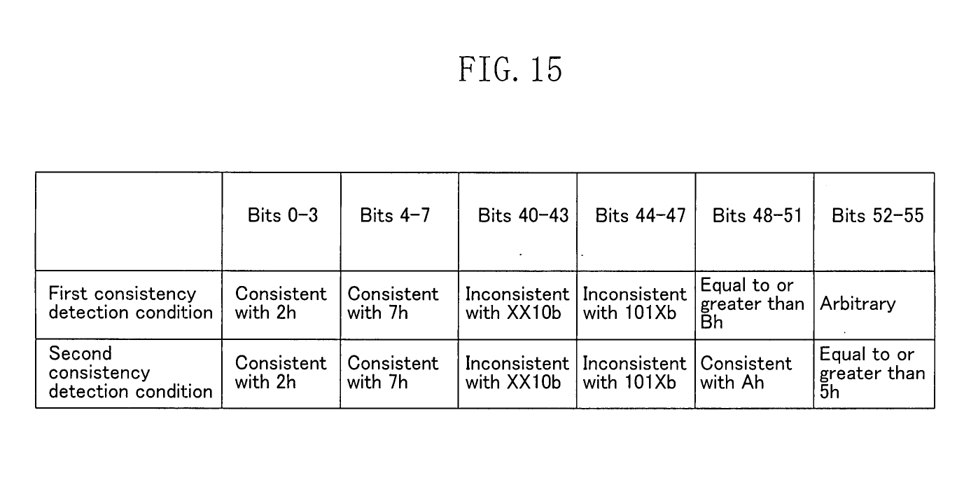

In view of the above, two types of consistency detection conditions are set as shown in FIG. 15.

The version number is a 5-bit field, which corresponds to the lower 2 bits of the data segment of the 40 to 43 bits and the upper 3 bits of the data segment of the 44th to 47th bits. Thus, inconsistency with the version number (=15h) is expressed by “(40th to 43rd bits are not consistent with XX10b (b is binary, X is arbitrary)) or (44th to 47th bits are not consistent with 101Xb)”. Further, the condition that “the section number is equal to or greater than A5h” is divided into two conditions that “the section number is equal to or greater than B0h or within A5h to AFh”.

The reference data is stored in the pattern memory 63 based on the first and second consistency detection conditions shown in FIG. 15 as described below.

It is assumed herein that the reference data of addresses 000h to 1BFh of the pattern memory 63 are all initialized to 0 which represents “inconsistency”. The first consistency detection condition corresponds to bit position 0 of the 32-bit reference data of the pattern memory 63. The second consistency detection condition corresponds to bit position 1 of the 32-bit reference data of the pattern memory 63.

Since as for the 0th to 3rd bits of the data segment, both the first and second consistency detection conditions are required to detect consistency with 2h, “1” which represents “consistency” is stored at bit position 0 and bit position 1 of address 002h that is obtained by adding together “2h” and the data segment position signal “000h” corresponding to the 0th to 3rd bits of the data segment.

Since as for the 4th to 7th bits consistency with 7h has to be detected, “1” which represents “consistency” is stored at bit position 0 and bit position 1 of address 017h that is obtained by adding together “7h” and the data segment position signal “010h” corresponding to the 4th to 7th bits of the data segment.

Since as for the 40th to 43rd bits, both the first and second consistency detection conditions are required to detect consistency with XX10b, “1” which represents “consistency” is stored at bit position 0 and bit position 1 of address 00000110XX10b that is obtained by adding together “XX10b” and the data segment position signal “060h” corresponding to the 40th to 43rd bits of the data segment.

Likewise, since as for the 44th to 47th bits the data segment position signal is 070h, “1” which represents “consistency” is stored at bit position 0 and bit position 1 of address 00000111101Xb.

As for the 48th to 51st bits of the data segment, it is necessary to detect a value equal to or greater than Bh with the first consistency detection condition. Consistency with the value equal to or greater than Bh means consistency with all of the data of Bh to Fh. Thus, “1” which represents “consistency” is stored at bit position 0 of addresses 08Bh to 08Fh that is obtained by adding together these values and the value of the data segment position signal corresponding to the 48th to 51st bits, “080h”. As for the second consistency detection condition, “1” is stored at bit position 1 of address 080h+Ah=08Ah in order to detect consistency with Ah.

Since as for the 52nd to 55th bits of the data segment it is only necessary to detect consistency at arbitrary value for the first consistency detection condition, “1” is stored at bit position 0 of address (data segment position signal 090h)+(arbitrary 4-bit value)=09Xh. As for the second consistency detection condition, “1” is stored at bit position 1 of address (data segment position signal 090h)+(5h to Fh)=095h to 09Fh in order to detect consistency with a value equal to or greater than 5h, i.e., 5h to Fh.

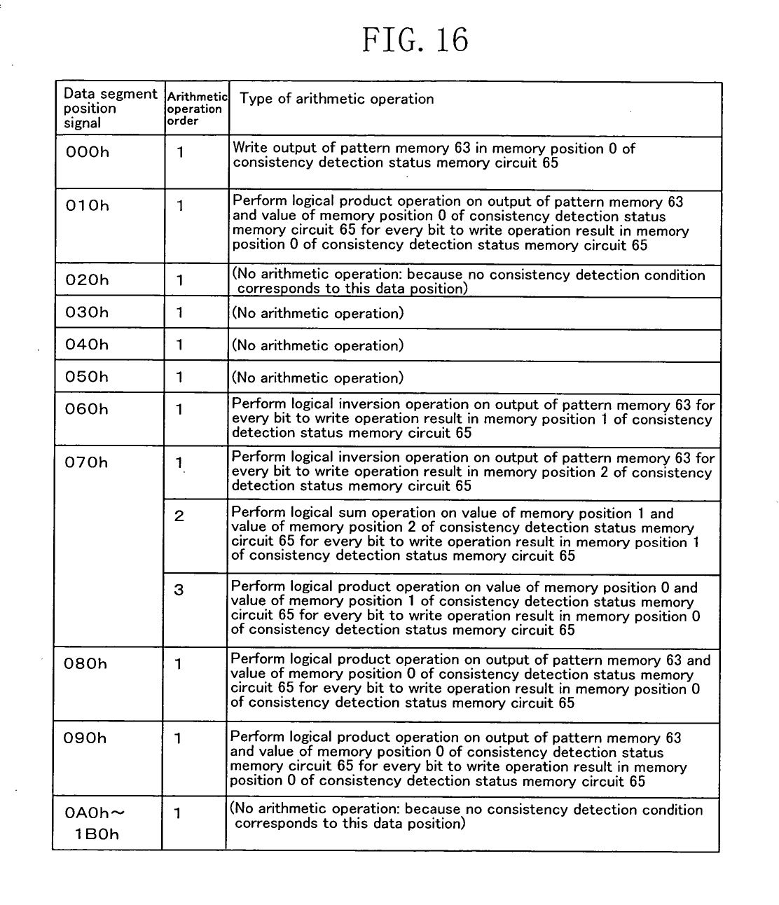

On the other hand, the type of arithmetic operation and the arithmetic operation order shown in FIG. 16 are set for each data segment in the arithmetic operation order memory circuit 67.

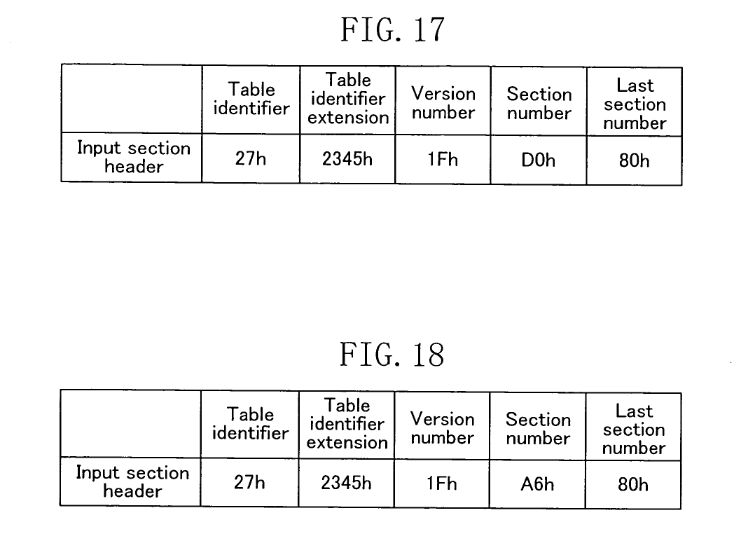

Now, consider a case where a section having a header shown in FIG. 17 is input. This section is consistent with the first consistency detection condition shown in FIG. 15.

The section header extraction circuit 61 extracts a data segment of 0th to 3rd bits (=2h) from the input section. At the same time, “000h” is output from the section header extraction circuit 61 as the data segment position signal. These two outputs are added together by the addition circuit 42, and “002h” is input to the pattern memory 63 as an address.

Value 00000003h stored at address 002h (only the values of bit position 0 and bit position 1 are “1” which denotes “consistency”) is read from the pattern memory 63 and input to the arithmetic operation circuit 64.

On the other hand, since the data segment position signal 000h is input to the arithmetic operation order memory circuit 67, an arithmetic operation instruction “to write the output of the pattern memory 63 in memory position 0 of the consistency detection status memory circuit 65” is input to the arithmetic operation circuit 64. The arithmetic operation circuit 64 writes “00000003h”, which is the output of the pattern memory 63, in memory position 0 of the consistency detection status memory circuit 65.

Then, the section header extraction circuit 61 extracts a data segment of 4th to 7th bits (=7h) from the input section. At the same time, “010h” is output from the section header extraction circuit 61 as the data segment position signal. These two outputs are added together by the addition circuit 42, and “017h” is input to the pattern memory 63 as an address.

Value 00000003h stored at address 017h (only the values of bit position 0 and bit position 1 are “1” which denotes “consistency”) is read from the pattern memory 63 and input to the arithmetic operation circuit 64.

On the other hand, since the data segment position signal 010h is input to the arithmetic operation order memory circuit 67, an arithmetic operation instruction “to perform a logical product operation of the output of the pattern memory 63 and the value of memory position 0 of the consistency detection status memory circuit 65 for every bit and write a result of the operation in memory position 0 of the consistency detection status memory circuit 65” is input to the arithmetic operation circuit 64. The arithmetic operation circuit 64 performs a logical product operation of “00000003h” which is the output of the pattern memory 63 and “00000003h” which is stored at memory position 0 of the consistency detection status memory circuit 65, for every bit and writes the operation result, 00000003h, in memory position 0 of the consistency detection status memory circuit 65.

At the time when the table identifier (the 0th to 7th bits from the section head) is input, the consistency detection status memory circuit 65 has “00000003h” which indicates consistency with the first and second consistency detection conditions.

Then, the section header extraction circuit 61 extracts a data segment of 24th to 27th bits (=2h) from the input section. At the same time, “020h” is output from the section header extraction circuit 61 as the data segment position signal. These two outputs are added together by the addition circuit 42, and “022h” is input to the pattern memory 63 as an address.

On the other hand, since the data segment position signal 020h is input to the arithmetic operation order memory circuit 67, an arithmetic operation instruction of “no arithmetic operation” is input to the arithmetic operation circuit 64. Thus, the data stored in the consistency detection status memory circuit 65 does not change irrespective of the output data from the pattern memory 63. The consistency detection status memory circuit 65 has “00000003h” which indicates the consistency with the first and second consistency detection conditions. This is because no consistency detection condition is set to the data segment of the 24th to 27th bits, which are the leading 4 bits of the table identifier extension, i.e., “consistency” is determined for any input data.

The arithmetic operation circuit 64 performs no arithmetic operation on the data segments of the 28th to 31st bits, the 32nd to 35th bits, and the 36th to 39th bits.

Then, the section header extraction circuit 61 extracts a data segment of 40th to 43rd bits (=3h) from the input section. This is because the upper 2 bits of the version number (11b) correspond to the lower 2 bits of the 40th to 43rd bits. At the same time, “060h” is output from the section header extraction circuit 61 as the data segment position signal. These two outputs are added together by the addition circuit 42, and “063h=000001100011b” is input to the pattern memory 63 as an address.

Value 00000000h stored at address 063h is read from the pattern memory 63 and input to the arithmetic operation circuit 64.

On the other hand, since the data segment position signal 060h is input to the arithmetic operation order memory circuit 67, an arithmetic operation instruction “to perform a logical inversion operation on the output of the pattern memory 63 for every bit and write the operation result in memory position 1 of the consistency detection status memory circuit 65” is input to the arithmetic operation circuit 64. The arithmetic operation circuit 64 performs a logical inversion operation on “00000000h”, which is the output of the pattern memory 63, for every bit and writes the operation result, FFFFFFFFh, in memory position 1 of the consistency detection status memory circuit 65.

Then, the section header extraction circuit 61 extracts a data segment of 44th to 47th bits (=111Xb) from the input section. This is because the lower 3 bits of the version number (111b) correspond to the upper 3 bits of the 44th to 47th bits. At the same time, “070h” is output from the section header extraction circuit 61 as the data segment position signal. These two outputs are added together by the addition circuit 42, and “00000111111Xb” is input to the pattern memory 63 as an address.

Value 00000000h stored at address 00000111111Xb is read from the pattern memory 63 and input to the arithmetic operation circuit 64.

On the other hand, since the data segment position signal 070h is input to the arithmetic operation order memory circuit 67, an arithmetic operation instruction “to perform a logical inversion operation on the output of the pattern memory 63 for every bit and write the operation result in memory position 2 of the consistency detection status memory circuit 65” is input to the arithmetic operation circuit 64 as the first arithmetic operation instruction. The arithmetic operation circuit 64 performs a logical inversion operation on “00000000h”, which is the output of the pattern memory 63, for every bit and writes the operation result, FFFFFFFFh, in memory position 2 of the consistency detection status memory circuit 65.

The second arithmetic operation instruction to the arithmetic operation circuit 64 is “to perform a logical sum operation on the value of memory position 1 and the value of memory position 2 of the consistency detection status memory circuit 65 for every bit and write the operation result in memory position 1 of the consistency detection status memory circuit 65”. The arithmetic operation circuit 64 performs a logical sum operation on FFFFFFFFh, which is the value of memory position 1 of the consistency detection status memory circuit 65, and FFFFFFFFh, which is the value of memory position 2 of the consistency detection status memory circuit 65, for every bit and writes the operation result, FFFFFFFFh, in memory position 1 of the consistency detection status memory circuit 65.

The third arithmetic operation instruction is “to perform a logical product operation on the value of memory position 0 and the value of memory position 1 of the consistency detection status memory circuit 65 for every bit and write the operation result in memory position 0 of the consistency detection status memory circuit 65”. The arithmetic operation circuit 64 performs a logical product operation on “00000003h”, which is the value of memory position 0 of the consistency detection status memory circuit 65, and FFFFFFFFh, which is the value of memory position 1 of the consistency detection status memory circuit 65, for every bit and writes the operation result, 00000003h, in memory position 0 of the consistency detection status memory circuit 65.

After the above arithmetic operations, the consistency detection status memory circuit 65 has, at memory position 0, value 00000003h which indicates the state of consistency with both the first consistency detection condition and the second consistency detection condition.

By employing the above arithmetic operation order, consistency can be detected in the case of “version number input is 1Fh” by consistency detection and logical arithmetic operation of a detection result on a 4-bit by 4-bit basis for the detection condition of 5-bit basis that “version number is inconsistent with 15h”.

Then, the section header extraction circuit 61 extracts a data segment of 48th to 51st bits (the upper 4 bits of the section number) (=Dh) from the input section. At the same time, “080h” is output from the section header extraction circuit 61 as the data segment position signal. These two outputs are added together by the addition circuit 42, and “08Dh” is input to the pattern memory 63 as an address.

Value 00000001h stored at address 08Dh (only the value of bit position 0 is “1” which denotes “consistency”) is read from the pattern memory 63 and input to the arithmetic operation circuit 64.

On the other hand, since the data segment position signal 080h is input to the arithmetic operation order memory circuit 67, an arithmetic operation instruction “to perform a logical product operation on the output of the pattern memory 63 and the value of memory position 0 of the consistency detection status memory circuit 65 for every bit and write the operation result in memory position 0 of the consistency detection status memory circuit 65” is input to the arithmetic operation circuit 64. The arithmetic operation circuit 64 performs a logical inversion operation of “00000001h” which is the output of the pattern memory 63 and “00000003h” stored at memory position 0 of the consistency detection status memory circuit 65 for every bit and writes the operation result, 00000001h, in memory position 0 of the consistency detection status memory circuit 65.

The consistency detection status memory circuit 65 has “00000001h” which indicates consistency with the first consistency detection condition.

Then, the section header extraction circuit 61 extracts a data segment of 52nd to 55th bits (the lower 4 bits of the section number) (=0h) from the input section. At the same time, “090h” is output from the section header extraction circuit 61 as the data segment position signal. These two outputs are added together by the addition circuit 42, and “090h” is input to the pattern memory 63 as an address.

Value 00000001h stored at address 090h (only the value of bit position 0 is “1” which denotes “consistency”) is read from the pattern memory 63 and input to the arithmetic operation circuit 64.

On the other hand, since the data segment position signal 090h is input to the arithmetic operation order memory circuit 67, an arithmetic operation instruction “to perform a logical product operation on the output of the pattern memory 63 and the value of memory position 0 of the consistency detection status memory circuit 65 for every bit and write the operation result in memory position 0 of the consistency detection status memory circuit 65” is input to the arithmetic operation circuit 64. The arithmetic operation circuit 64 performs a logical inversion operation of “00000001h” which is the output of the pattern memory 63 and “00000001h” stored at memory position 0 of the consistency detection status memory circuit 65 for every bit and writes the operation result, 00000001h, in memory position 0 of the consistency detection status memory circuit 65.

The consistency detection status memory circuit 65 has “00000001h” which indicates consistency with the first consistency detection condition.

Thereafter, the section header extraction circuit 61 sequentially extracts a data segment of the 56th to 59th bits (the upper 4 bits of the last section number) (=8h) and a data segment of the 60th to 63rd bits (the lower 4 bits of the last section number) (=0h) from the input section. The data segment position signals “0A0h” and “0B0h” for the above data segments are input to the arithmetic operation order memory circuit 67. The arithmetic operation instruction to the arithmetic operation order memory circuit 67 at and after 0A0h is “no arithmetic operation”. Thus, the state of the consistency detection status memory circuit 65 does not change till the final data of the section header is input.

When a data segment of the 124th to 127th bits is extracted by the section header extraction circuit 61 from the input section, and “1B0h” is input to the consistency determination memory circuit 46 as the data segment position signal, consistency detection between the input section and the consistency detection condition is completed, and value 00000001h which is stored at memory position 0 of the consistency detection status memory circuit 65 is input to the consistency determination memory circuit 46.

Since the input to the consistency determination memory circuit 46 is not 0, it is determined that the input section data is consistent with the first consistency detection condition, and “consistency” is output as the consistency determination result.

In this way, it is determined that the input section data is consistent with the first consistency detection condition, “consistency” is output from the consistency determination memory circuit 46, and “consistency” is also output from the header consistency detection circuit 31.

Next, consider a case where a section having a header shown in FIG. 18 is input. This section is consistent with the second consistency detection condition shown in FIG. 15.

The table identifier, the table identifier extension, the version number and the last section number are the same as those of the input section of FIG. 17, and therefore, descriptions thereof are herein omitted.

The section header extraction circuit 61 extracts a data segment of 48th to 51st bits (the upper 4 bits of the section number) (=Ah) from the input section. At the same time, “080h” is output from the section header extraction circuit 61 as the data segment position signal. These two outputs are added together by the addition circuit 42, and “08Ah” is input to the pattern memory 63 as an address.

Value 00000002h stored at address 08Ah (only the value of bit position 1 is “1” which denotes “consistency”) is read from the pattern memory 63 and input to the arithmetic operation circuit 64.

On the other hand, since the data segment position signal 080h is input to the arithmetic operation order memory circuit 67, an arithmetic operation instruction “to perform a logical product operation on the output of the pattern memory 63 and the value of memory position 0 of the consistency detection status memory circuit 65 for every bit and write the operation result in memory position 0 of the consistency detection status memory circuit 65” is input to the arithmetic operation circuit 64. The arithmetic operation circuit 64 performs a logical inversion operation of “00000002h” which is the output of the pattern memory 63 and “00000003h” stored at memory position 0 of the consistency detection status memory circuit 65 for every bit and writes the operation result, 00000002h, in memory position 0 of the consistency detection status memory circuit 65.

The consistency detection status memory circuit 65 has “00000002h” which indicates consistency with the first consistency detection condition.

Then, the section header extraction circuit 61 extracts a data segment of 52nd to 55th bits (the lower 4 bits of the section number) (=6h) from the input section. At the same time, “090h” is output from the section header extraction circuit 61 as the data segment position signal. These two outputs are added together by the addition circuit 42, and “096h” is input to the pattern memory 63 as an address.

Value 00000002h stored at address 096h (only the value of bit position 1 is “1” which denotes “consistency”) is read from the pattern memory 63 and input to the arithmetic operation circuit 64.

On the other hand, since the data segment position signal 090h is input to the arithmetic operation order memory circuit 67, an arithmetic operation instruction “to perform a logical product operation on the output of the pattern memory 63 and the value of memory position 0 of the consistency detection status memory circuit 65 for every bit and write the operation result in memory position 0 of the consistency detection status memory circuit 65” is input to the arithmetic operation circuit 64. The arithmetic operation circuit 64 performs a logical inversion operation of “00000002h” which is the output of the pattern memory 63 and “00000002h” stored at memory position 0 of the consistency detection status memory circuit 65 for every bit and writes the operation result, 00000002h, in memory position 0 of the consistency detection status memory circuit 65.

The consistency detection status memory circuit 65 has “00000002h” which indicates consistency with the second consistency detection condition.

If the data segment at the 52nd to 55th bits (the lower 4 bits of the section number) is equal to or greater than 5h, “00000002h” is read from the pattern memory 63. Thus, consistency with the condition can be detected when the upper 4 bits of the section number is A and the lower 4 bits of the section number is equal to or greater than 5h, i.e., when the section number is equal to or greater than A5h and equal to or smaller than AFh.

In this way, it can be detected that the input section shown in FIG. 18 is consistent with the second consistency detection condition.

Consistency with the second consistency detection condition is detected in the case of section numbers A5h to AFh. Consistency with the first consistency detection condition is detected in the case of a section number equal to or greater than B0h. Thus, if the section number of the input section is equal to or greater than A5h, consistency with the first or second consistency detection condition is detected.

As described above, in the section data selection circuit 25 of embodiment 2, 32 types of consistency detection conditions for detecting consistency with the section header can be set at the maximum, and a section having a section header which is consistent with any of the consistency detection conditions can be selected and output.

Since the section header is divided into 4-bit data segments, and comparison with the consistency detection conditions can be completed through a single read operation to the pattern memory 63 for each data segment, the access bandwidth of a memory required by the header consistency detection circuit 31 is suppressed to a small width.

For example, even when selection of the section input at 12.5 Mbytes/sec is performed for the 32 types of conditions, only the memory access bandwidth of 12.5 M times×2×32 bits=100 Mbytes/sec is required at the maximum. Thus, the requested performance is greatly reduced as compared with 800 Mbytes/sec that is required in the conventional technique.

Since the reference data which indicates consistency/inconsistency with the consistency detection conditions for all of data values is stored in the pattern memory 63 in advance, and the arithmetic operation instruction of the reference data and the consistency detection conditions is designated for each data segment position, not only detection of consistency with condition data but also detection of inconsistency, comparison of largeness, suppression of comparison for a part of field data, etc., can be achieved. As a result, highly flexible detection conditions can be set.

In embodiment 2, the input section to be compared is divided into 4-bit data segments, whereby the capacity of the pattern memory is decreased from 1314 words to 448 words although the detection conditions are doubled, i.e., extended to the leading 16 bytes, as compared with embodiment 1.

In embodiment 2, 32 types of consistency detection conditions can be set in the pattern memory 63, but the present invention is not limited thereto. According to the present invention, any number of conditions can be employed by changing the number of bits dealt with in the pattern memory 63, the arithmetic operation circuit 64, the consistency detection status memory circuit 65 and the consistency determination memory circuit 46 according to the number of consistency detection conditions.

In the above description, the header consistency detection circuit 31 of embodiment 2 performs consistency detection for the fields of the leading 16 bytes of the section data, but the fields to be subjected to consistency detection are not limited thereto. Consistency detection can be performed on data of any size.

In the above description, only a result that indicates consistency or not is output as the consistency determination result from the consistency determination memory circuit 46 of embodiment 2. However, in addition, an input from the consistency detection status memory circuit 65 which represents a condition with which consistency is detected may be stored, and this information may be output. Thus, the section data selection circuit 25 is capable of not only determining consistency with a consistency detection condition to determine whether or not section data is allowed to be output but also outputting information indicating a condition with which consistency is detected.

It should be noted that the details of the arithmetic operations for the arithmetic operation order memory circuit 67 of embodiment 2 are not limited to those illustrated above.

In the above description of embodiment 2, the pattern memory 63 is a memory incorporated in the header consistency detection circuit 31, but the present invention is not limited thereto. The pattern memory 43 may be provided outside the header consistency detection circuit 31. For example, the pattern memory 43 may be realized by a main storage memory of the CPU 29. As described above, only a memory access bandwidth of 100 Mbytes/sec is used for executing selection of a section input at 12.5 Mbytes/sec with 32 types of conditions. The main storage memory of the CPU 29 generally has an access bandwidth of several hundreds of megabytes/sec. Thus, an embodiment wherein a header consistency detection circuit 31 uses a 100 Mbytes/sec portion of the access bandwidth is practically realizable. In the case where the pattern memory 63 is realized by an external large-capacity memory, the increase in the capacity of the pattern memory 63, which is required when increasing the number of fields to be subjected to consistency detection or the number of consistency detection conditions, is readily achieved.

In the above example described in embodiment 2, extraction of a section header and addition of a data segment and the data segment position signal to make an address to the pattern memory are realized by a circuit, but the present invention is not limited thereto. Extraction of a data segment from section data, counting of the data segment position, and addition of the data segment position information in the form of the data segment position signal and the data segment can be entirely or partially realized by software. In embodiment 2, extraction of the data segment is data processing of 12.5 Mbytes/sec and therefore can be realized by software.

In the above-described example of embodiment 2, the arithmetic operation order memory circuit 67, the arithmetic operation circuit 64, the consistency detection status memory circuit 65 and the consistency determination memory circuit 46 are realized by circuits, but the present invention is not limited thereto. These components may be realized by software processing.

In a possible example, the pattern memory 63 is realized as a main storage memory of the CPU 29 as described above, and the other processing of the header consistency detection circuit 31 is realized by software. That is, the header consistency detection circuit 31 described in embodiment 2 is partially or entirely realized by software.

### Embodiment 3

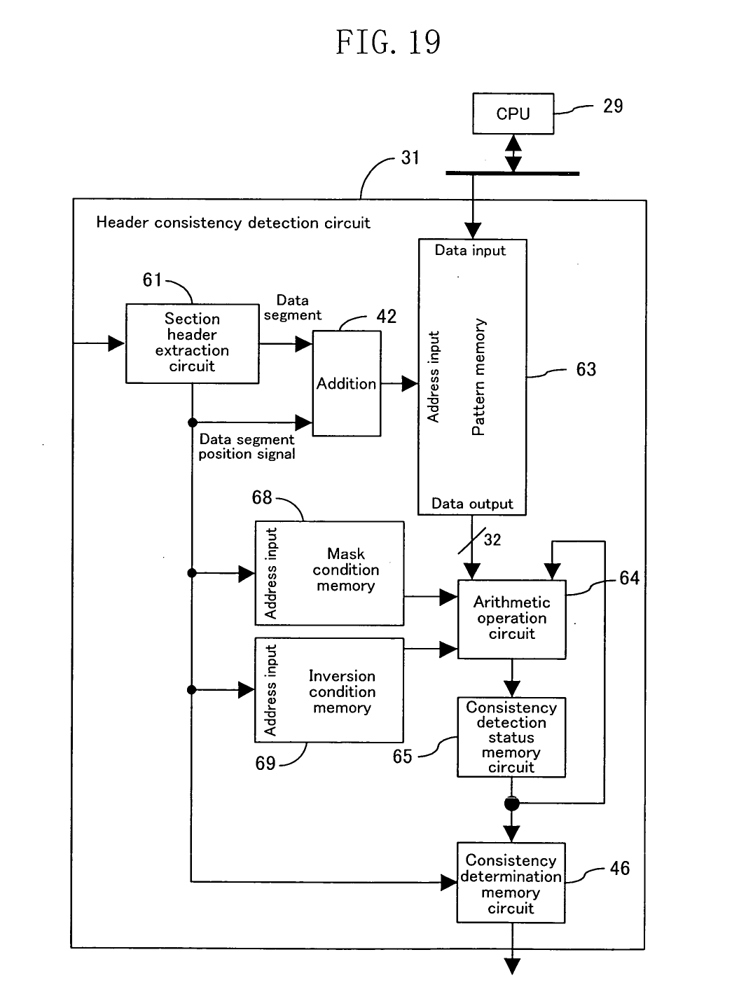

FIG. 19 shows a structure of a header consistency detection circuit according to embodiment 3 of the present invention. The header consistency detection circuit 31 includes a section header extraction circuit 61, an addition circuit 42, a pattern memory 63, an arithmetic operation circuit 64, a consistency detection status memory circuit 65, a consistency determination memory circuit 46, a mask condition memory 68 and an inversion condition memory 69.

The section header extraction circuit 61 extracts the fields which constitute the section header, such as table identifier, table identifier extension, version number, current next indicator, section number, last section number, etc., and outputs the extracted fields. In this process, if the data length of each field exceeds a specific data size (4 bits in embodiment 3), each field is divided into 4-bit data segments, and the data segments are sequentially output. The section header extraction circuit 61 also outputs a data segment position signal, which indicates the position of this data segment in the section header, while outputting the extracted data segment. It should be noted that in embodiment 3 each field is divided into 4-bit data segments, but the data size of the data segments is not limited to 4 bits.

The addition circuit 42 adds together the data segment and the data segment position signal, which are output from the section header extraction circuit 61, to output an addition result to the pattern memory 63.

The pattern memory 63 contains in advance, in an address corresponding to each of possible values that each data segment of the section header can have, reference data indicating that the possible value is consistent with the consistency detection condition (“consistency”) or reference data indicating that the possible value is inconsistent with the consistency detection condition (“inconsistency”) under the control of the CPU 29 as in embodiment 1. In the case where the addition result of the data segment and the data segment position signal, which are input from the addition circuit 42, is read as an address from the pattern memory 63, the reference data indicating whether or not this data segment is consistent with a consistency detection condition is output.

The consistency detection status memory circuit 65 is capable of storing a plurality of words of 32-bit information. Each bit of each word stores the status of a consistency detection process. At every start of the section, the consistency detection status memory circuit 65 is initialized to a state where nothing is stored. Thereafter, the consistency detection status memory circuit 65 stores the arithmetic operation result of the arithmetic operation circuit 64 every time comparison of each field data is executed.

The arithmetic operation circuit 64 receives the reference data from the pattern memory 63 and reads the value stored in the consistency detection status memory circuit 65 to perform a bit operation on these data with the data output from the mask condition memory 68 and the inversion condition memory 69. The arithmetic operation circuit 64 outputs the result of the bit operation to the consistency detection status memory circuit 65.

The mask condition memory 68 stores the conditions for masking consistency detection in conjunction with the data segments extracted by the section header extraction circuit 61. Each bit of the mask condition memory 68 corresponds to respective one of independent consistency detection conditions.

The inversion condition memory 69 stores the conditions for inverting a consistency detection result in conjunction with the data segments extracted by the section header extraction circuit 61. Each bit of the inversion condition memory 69 corresponds to respective one of independent consistency detection conditions.

After reference to the pattern memory 63 has been completed for all of the fields of the section header of a certain section, the consistency determination memory circuit 46 reads the data stored in the consistency detection status memory circuit 65. If at least one bit of the output of the consistency detection status memory circuit 65 indicates “consistency”, the consistency determination memory circuit 46 stores “consistency”. If otherwise, the consistency determination memory circuit 46 stores “inconsistency”. In this way, a consistency determination result between a section header and the consistency detection conditions is stored in and output from the consistency determination memory circuit 46.

The function and operation of the header consistency detection circuit 31 is described more specifically.

The section header extraction circuit 61 extracts the fields, such as the table identifier, etc., as data segments from a data sequence which constitute a section header. Further, if the data length of each field exceeds 4 bits, each field is divided into 4-bit data segments, and the data segments are sequentially output. For example, two 4-bit data segments at the head of the section correspond to the table identifier.

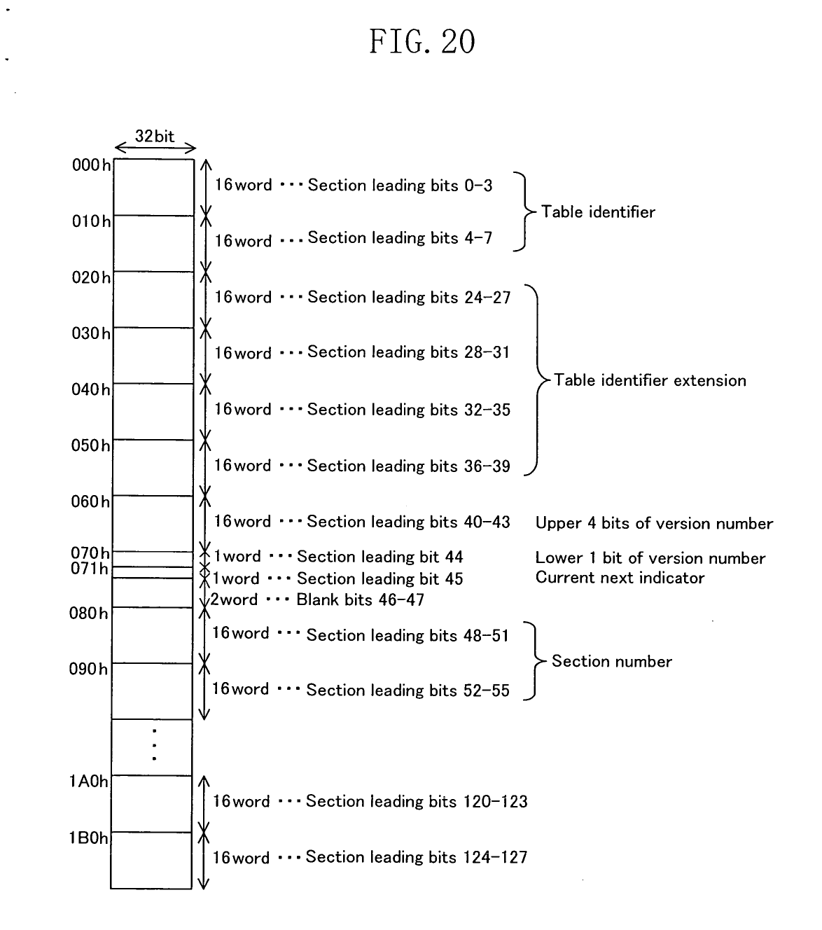

FIG. 20 shows an address map of the pattern memory 63. The pattern memory 63 is a memory of 448 words. As shown in FIG. 20, addresses 000 to 00Fh correspond to the possible values 0 to Fh that the data segment of the 0th to 3rd bits of the section can have, and addresses 010 to 01F correspond to the possible values 0 to Fh that the data segment of the 4th to 7th bits of the section can have. Subsequently, the possible values that each data segment except for the table length field of the section can have correspond to the addresses up to address 1BF. Each address can store the reference data of 32 bits. Each bit of the reference data corresponds to an independent consistency detection condition. That is, according to embodiment 3, consistency detection with the 32 types of consistency detection conditions is possible.

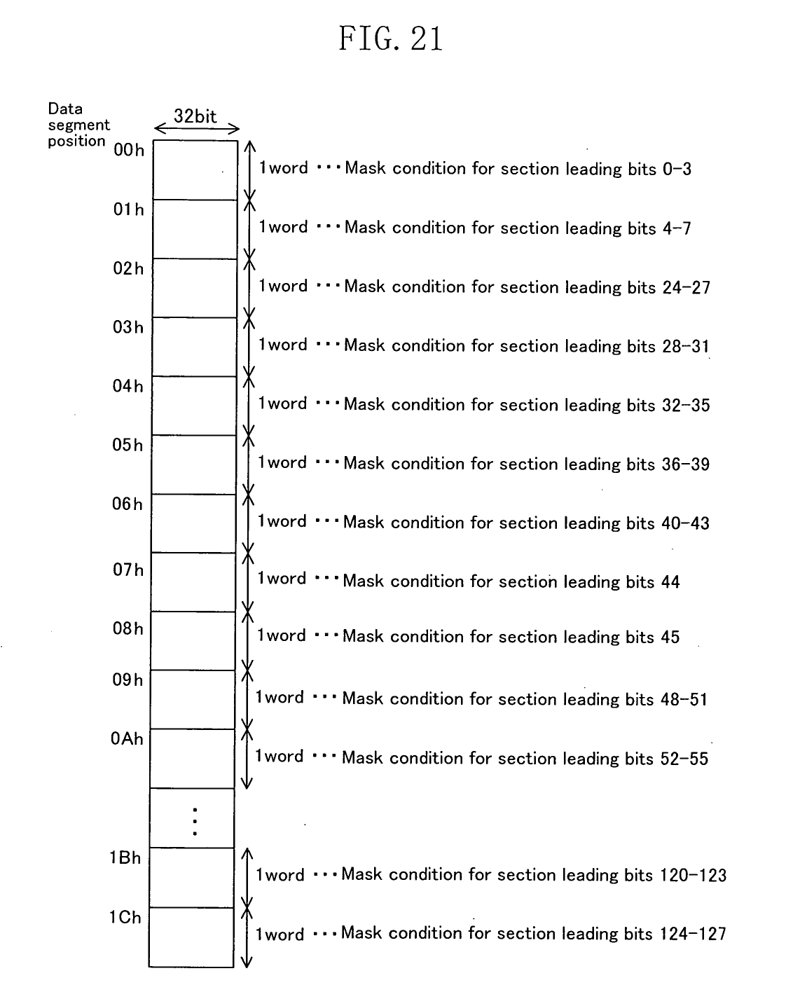

FIG. 21 shows an address map of the mask condition memory 68. As shown in FIG. 21, address 00h stores a mask condition corresponding to the data segment of the 0th to 3rd bits, and address 01h stores a mask condition corresponding to the data segment of the 4th to 7th bits. Subsequently, the mask conditions of respective data segments except for the table length field of the section are stored in the addresses up to address 1Dh. Each address can store the mask conditions of 32 bits. Each bit corresponds to an independent consistency detection condition. That is, in embodiment 3, the mask condition is independently set for each of the 32 types of consistency detection conditions.

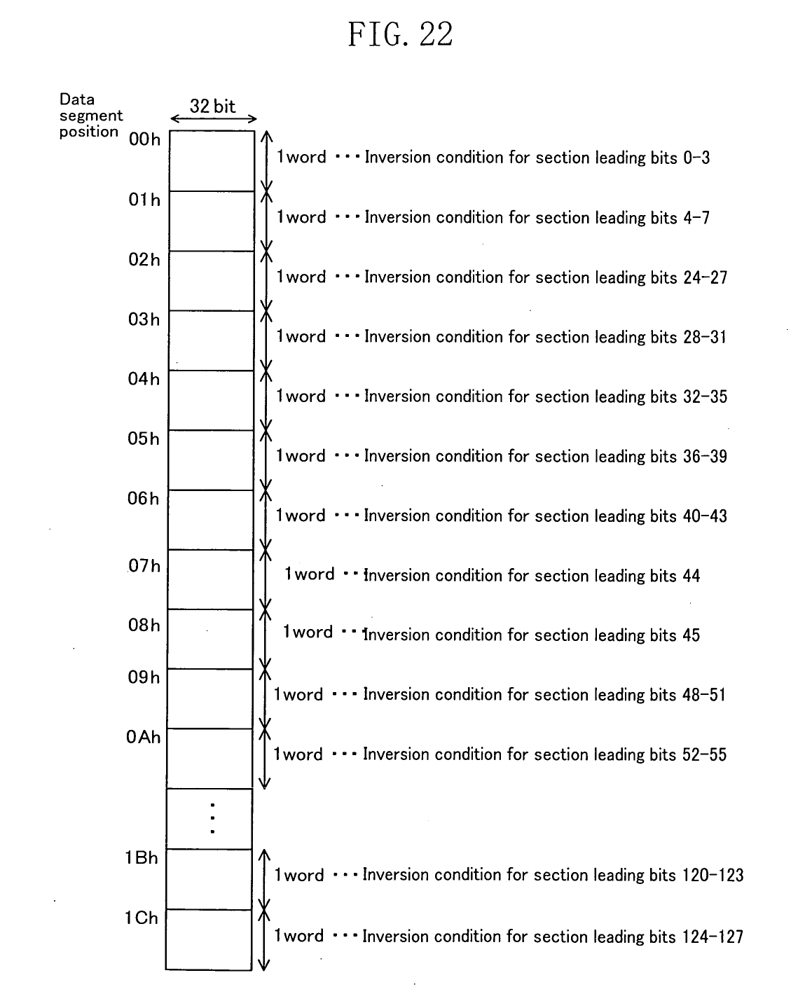

FIG. 22 shows an address map of the inversion condition memory 69. As shown in FIG. 22, address 00h stores an inversion condition corresponding to the data segment of the 0th to 3rd bits, and address 01h stores an inversion condition corresponding to the data segment of the 4th to 7th bits. Subsequently, the inversion conditions of respective data segments except for the table length field of the section are stored in the addresses up to address 1Dh. Each address can store the inversion conditions of 32 bits. Each bit corresponds to an independent consistency detection condition. That is, in embodiment 3, the inversion condition is independently set for each of the 32 types of consistency detection conditions.

In embodiment 3, an example wherein a section consistent with the following conditions is set to the first consistency detection condition for selection is considered:
Table identifier is consistent with 27h;
Upper 4 bits of version number is inconsistent with 2h (inversion of result of consistency); and
Upper 4 bits of section number is masked (consistency detection is not performed).

The reference data is stored in the pattern memory 63 based on the above conditions as described below.

It is assumed herein that the pattern memory 63 is all initialized to 0 which represents “inconsistency”. The mask condition memory 68 is all initialized to 0 which represents “no masking”. The inversion condition memory 69 is all initialized to 0 which represents “no result inversion”.

It is assumed that the first consistency detection condition corresponds to bit position 0 of the reference data of the pattern memory 63. The table identifier corresponds to the data segment of the 0th to 3rd bits. Since as for this it is necessary to detect consistency with “2h” as to the first consistency detection condition, “1” which indicates “consistency” is stored at bit position 0 of address 002h which is obtained by adding together 2h and field position signal 000h corresponding to the data segment of the 0th to 3rd bits.

Since as for the 4th to 7th bits it is necessary to detect consistency with 7h, “1” which indicates “consistency” is stored at bit position 0 of address 017h which is obtained by adding together 7h and field position signal 010h corresponding to the data segment of the 4th to 7th bits.

The upper 4 bits of the version number correspond to the data segment of the 40th to 43rd bits. Thus, as for inconsistency with the upper 4 bits of the version number (=2h), “1” which indicates “consistency” is stored at bit position 0 corresponding to the first consistency detection condition in address 41h of the pattern memory 63, and “1” which indicates “inversion” is stored at bit position 0 corresponding to the first consistency detection condition in address 06h of the inversion condition memory 69.

The upper 4 bits of the section number correspond to the data segment of the 48th to 51st bits. Thus, in the case of masking the upper 4 bits of the section number, “1” which indicates “inversion” is stored at bit position 0 corresponding to the first consistency detection condition at address 09h of the mask condition memory 68. In this case, the data of bit position 0 corresponding to the first consistency detection condition in an address which corresponds to the data segment of the 48th to 51st bits of the pattern memory 63 has no relation to the consistency detection.

Next, an example wherein section data having the following field data is input is considered:
Table identifier is consistent with 27h;
Upper 4 bits of version number is 3h; and
Upper 4 bits of section number is 1h.

The section header extraction circuit 61 extracts the data segment of the 0th to 3rd bits (=2h) from the input section. At the same time, “00h” is output from the section header extraction circuit 61 as the data segment position signal. These two outputs are added together by the addition circuit 42, and “002h” is input to the pattern memory 63 as an address. Value 00000001h stored at address 002h (only the value of bit position 1 is “1” which denotes “consistency”) is read from the pattern memory 63 and input to the arithmetic operation circuit 64.

On the other hand, since the data segment position signal 00h is input to the mask condition memory 68, an arithmetic operation instruction “not to mask the output of the pattern memory 63” is input to the arithmetic operation circuit 64. Since the data segment position signal 00h is input to the inversion condition memory 69, an arithmetic operation instruction “not to invert the output of the pattern memory 63” is input to the arithmetic operation circuit 64.

The arithmetic operation circuit 64 performs a bit operation of “000000001h” which is the output of the pattern memory 63, “00000000h” which is the output of the mask condition memory 68, and “00000000h” which is the output of the inversion condition memory 69, and the operation result, 00000001h, is stored in the consistency detection status memory circuit 65.

The section header extraction circuit 61 extracts the data segment of the 4th to 7th bits (=7h) from the input section. At the same time, “01h” is output from the section header extraction circuit 61 as the data segment position signal. These two outputs are added together by the addition circuit 42, and “017h” is input to the pattern memory 63 as an address. Value 00000001h stored at address 017h (only the value of bit position 0 is “1” which denotes “consistency”) is read from the pattern memory 63 and input to the arithmetic operation circuit 64.

On the other hand, since the data segment position signal 01h is input to the mask condition memory 68, an arithmetic operation instruction “not to mask the output of the pattern memory 63” is input to the arithmetic operation circuit 64. Since the data segment position signal 01h is input to the inversion condition memory 69, an arithmetic operation instruction “not to invert the output of the pattern memory 63” is input to the arithmetic operation circuit 64.

The arithmetic operation circuit 64 performs a bit operation of “00000001h” which is the output of the pattern memory 63, “00000000h” which is the output of the mask condition memory 68, and “00000000h” which is the output of the inversion condition memory 69. The result of the bit operation, 00000001h, and the output of the consistency detection status memory circuit 65 are subjected to a bit multiplication. The result of the bit multiplication is newly stored in the consistency detection status memory circuit 65.

At the time when the table identifier (the 0th to 7th bits from the section head) is input, the consistency detection status memory circuit 65 has “00000001h” which indicates consistency with the first consistency detection condition.

The section header extraction circuit 61 extracts the data segment of the 40th to 43rd bits (=3h) from the input section. At the same time, “06h” is output from the section header extraction circuit 61 as the data segment position signal. These two outputs are added together by the addition circuit 42, and “063h” is input to the pattern memory 63 as an address.

On the other hand, since the data segment position signal 06h is input to the mask condition memory 68, an arithmetic operation instruction “not to mask the output of the pattern memory 63” is input to the arithmetic operation circuit 64. Since the data segment position signal 06h is input to the inversion condition memory 69, an arithmetic operation instruction “to invert the output of the pattern memory 63” is input to the arithmetic operation circuit 64.

The arithmetic operation circuit 64 performs a bit operation of “00000000h” which is the output of the pattern memory 63, “00000000h” which is the output of the mask condition memory 68, and “00000001h” which is the output of the inversion condition memory 69. The result of the bit operation, 00000001h, and the output of the consistency detection status memory circuit 65 are subjected to a bit multiplication. The result of the bit multiplication is newly stored in the consistency detection status memory circuit 65.

Then, the section header extraction circuit 61 extracts the data segment of the 48th to 51st bits (=1h) from the input section. At the same time, “08h” is output from the section header extraction circuit 61 as the data segment position signal. These two outputs are added together by the addition circuit 42, and “081h” is input to the pattern memory 63 as an address.

On the other hand, since the data segment position signal 08h is input to the mask condition memory 68, an arithmetic operation instruction “to mask the output of the pattern memory 63” is input to the arithmetic operation circuit 64. Since the data segment position signal 08h is input to the inversion condition memory 69, an arithmetic operation instruction “not to invert the output of the pattern memory 63” is input to the arithmetic operation circuit 64.

The arithmetic operation circuit 64 performs a bit operation of “00000000h” which is the output of the pattern memory 63, “00000001h” which is the output of the mask condition memory 68, and “00000000h” which is the output of the inversion condition memory 69. The result of the bit operation, 00000001h, and the output of the consistency detection status memory circuit 65 are subjected to a bit multiplication. The result of the bit multiplication is newly stored in the consistency detection status memory circuit 65.

Consistency detection between the input section data and the consistency detection conditions is sequentially performed as described above. At the time when consistency detection for all of the input data segments is completed, value 00000001h stored in the consistency detection status memory circuit 65 is input to the consistency determination memory circuit 46. Since the input to the consistency determination memory circuit 46 is not 0, it is determined that the input section data is consistent with the first consistency detection condition, and “consistency” is output as the consistency determination result.

As described above, in the section data selection circuit 25 of embodiment 3, 32 types of consistency detection conditions for detecting consistency with the section header can be set at the maximum, and a section having a section header which is consistent with any of the consistency detection conditions can be selected and output.

When a section header is extracted, the section header is divided into the fields, such as table identifier, table identifier extension, version number, current next indicator, section number, last section number, etc. If the data length of each field exceeds 4 bits, each field is divided into 4-bit data segments. An inversion condition and mask condition are set for each data segment, whereby flexible comparison conditions required for selection of section data can be realized with a smaller area as compared with embodiment 2.

Since comparison with the consistency detection conditions can be completed through a single read operation to the pattern memory 63 for each data segment, the access bandwidth of a memory required by the header consistency detection circuit 31 is greatly suppressed as compared with the conventional techniques.

In the above example of embodiment 3, 32 types of consistency detection conditions are set in the pattern memory, but the present invention is not limited thereto. According to the present invention, any number of conditions can be employed by changing the number of bits dealt with in the pattern memory 63, the arithmetic operation circuit 64, the mask condition memory 68, the inversion condition memory 69, the consistency detection status memory circuit 65, and the consistency determination memory circuit 46 according to the number of consistency detection conditions.

In the above description, the header consistency detection circuit 31 of embodiment 3 performs consistency detection for the fields of the leading 16 bytes of the section data, but the fields to be subjected to consistency detection are not limited thereto. Consistency detection can be performed on data of any size.

In embodiment 3, the pattern memory 63, the mask condition memory 68 and the inversion condition memory 69 are provided as separate memory components. However, according to the present invention, these components may use different areas in the same memory. In the above description of embodiment 3, the pattern memory 63, the mask condition memory 68 and the inversion condition memory 69 are memories incorporated in the header consistency detection circuit 31, but the present invention is not limited thereto. These memories may be provided outside the header consistency detection circuit 31. For example, these memories may be realized by a main storage memory of the CPU 29.

In the above-described example of embodiment 3, the arithmetic operation circuit 64, the consistency detection status memory circuit 65 and the consistency determination memory circuit 46 are realized by circuits, but the present invention is not limited thereto. These components may be realized by software processing.

In a possible example, the pattern memory 63, the mask condition memory 68 and the inversion condition memory 69 are realized as a main storage memory of the CPU 29 as described above, and the other processing of the header consistency detection circuit 31 is realized by software. That is, the header consistency detection circuit 31 described in embodiment 3 is partially or entirely realized by software.

1. A data consistency detection device for determining whether or not input data including a plurality of data segments is consistent with a predetermined detection condition, the device comprising:
a first memory for storing in advance, in an address assigned to each of possible values that each of the plurality of data segments can have, reference data which indicates that the possible value is consistent with the detection condition (“consistency”) or reference data which indicates that the possible value is inconsistent with the detection condition (“inconsistency”) based on the detection condition; and
a data extraction section for sequentially extracting a data segment from the input data to supply an address corresponding to a value of the extracted data segment to the first memory,
wherein the first memory outputs reference data stored in the address supplied from the data extraction section, and
the data consistency detection device further comprises a determination section for determining whether or not the input data is consistent with the detection condition based on the reference data output from the first memory.

2. The data consistency detection device of claim 1, wherein:
the detection condition includes a first detection condition; and
the reference data stored in the first memory in advance includes first data in which one of first and second values is set based on the first detection condition.

3. The data consistency detection device of claim 2, wherein:
the detection condition further includes a second detection condition; and
the reference data stored in the first memory in advance includes second data in which one of the first and second values is set based on the second detection condition.

4. The data consistency detection device of claim 1, wherein:
if the reference data output from the first memory indicates “consistency” for all of the plurality of data segments included in the input data, the determination section determines that the input data is consistent with the detection condition.

5. The data consistency detection device of claim 1, wherein:
the first memory stores the reference data in advance in an address generated based on a position of each of the plurality of data segments in the input data and each of the possible values that the data segment can have; and
a data extraction section supplies to the first memory an address generated based on a position of the extracted data segment in the input data and a value of the extracted data segment.

6. The data consistency detection device of claim 5, wherein each of the plurality of data segments constitutes one piece of byte data.

7. The data consistency detection device of claim 5, wherein each of the plurality of data segments constitutes one piece of field data.

8. The data consistency detection device of claim 4, wherein:
the determination section includes
a logical operation section and
a second memory for storing output data of the logical operation section;
if both the reference data output from the first memory and the output data stored in the second memory indicate “consistency”, the logical operation section outputs the data which indicates “consistency”;
if at least one of the reference data output from the first memory and the output data stored in the second memory indicates “inconsistency”, the logical operation section outputs the data which indicates “inconsistency”;
the second memory stores the data which indicates “consistency” as an initial value; and
the second memory outputs, as consistency determination information, the output data of the logical operation section for the last one of the plurality of data segments extracted from the input data by the data extraction section.

9. The data consistency detection device of claim 1, wherein:
a predetermined arithmetic operation is assigned to each of the plurality of data segments;
the determination section includes
a logical operation section and
a second memory for storing output data of the logical operation section;
the logical operation section performs an arithmetic operation assigned to a data segment which corresponds to the reference data output from the first memory on at least one of the reference data and the output data stored in the second memory to output a result of the arithmetic operation;
the second memory stores the data which indicates “consistency” as an initial value; and
the second memory outputs, as consistency determination information, the output data of the logical operation section for the last one of the plurality of data segments extracted from the input data by the data extraction section.

10. The data consistency detection device of claim 9, wherein:
the second memory is capable of storing a plurality of pieces of the output data of the logical operation section; and
the logical operation section performs an arithmetic operation assigned to a data segment which corresponds to the reference data output from the first memory on at least one of the reference data and the plurality of pieces of output data stored in the second memory to output a result of the arithmetic operation.

11. A data selection device, comprising:
the data consistency detection device of claim 1; and
a data delay section for retaining the input data till the determination performed in the data consistency detection device as to whether or not the input data is consistent with the detection condition is completed,
wherein if the data consistency detection device determines that the input data is consistent with the detection condition, the data delay section outputs the retained input data, and
if the data consistency detection device determines that the input data is inconsistent with the detection condition, the data delay section does not output the retained input data.

12. A data consistency detection method for determining whether or not input data including a plurality of data segments is consistent with a predetermined detection condition, the method comprising:
step (a) of storing in a first memory in advance, at an address assigned to each of possible values that each of the plurality of data segments can have, reference data which indicates that the possible value is consistent with the detection condition (“consistency”) or reference data which indicates that the possible value is inconsistent with the detection condition (“inconsistency”) based on the detection condition;
step (b) of sequentially extracting a data segment from the input data to generate an address corresponding to a value of the extracted data segment;
step (c) of reading reference data stored in an address generated at step (b) from the first memory; and
step (d) of determining whether or not the input data is consistent with the detection condition based on the reference data output from the first memory at step (c).

13. The data consistency detection method of claim 12, wherein step (d) includes the step of determining that the input data is consistent with the detection condition if the reference data read from the first memory indicates “consistency” for all of the plurality of data segments included in the input data.

14. The data consistency detection method of claim 12, wherein:
step (a) includes the step of storing the reference data in advance in an address generated based on a position of each of the plurality of data segments in the input data and each of the possible values that the data segment can have; and
step (b) includes the step of generating an address based on a position of the extracted data segment in the input data and a value of the extracted data segment.

15. The data consistency detection method of claim 13, wherein step (d) includes:
step (e) of storing the data which indicates “consistency” as an initial value in a second memory;
step (f) of storing the data which indicates “consistency” in the second memory if both the reference data read from the first memory at step (c) and the data stored in the second memory indicate “consistency” and storing the data which indicates “inconsistency” in the second memory if at least one of the reference data read from the first memory at step (c) and the data stored in the second memory indicates “inconsistency”; and
step (g) of outputting, as consistency determination information, the data stored in the second memory at step (f) for the last one of the plurality of data segments extracted from the input data at step (b).

16. The data consistency detection method of claim 12, further comprising step (e) of assigning a predetermined arithmetic operation to each of the plurality of data segments,
wherein step (d) includes:
step (f) of storing the data which indicates “consistency” as an initial value in a second memory;
step (g) of performing an arithmetic operation assigned to a data segment which corresponds to the reference data read from the first memory at step (c) on at least one of the reference data and the output data stored in the second memory to store a result of the arithmetic operation in the second memory; and
step (h) of outputting, as consistency determination information, the data stored in the second memory at step (g) for the last one of the plurality of data segments extracted from the input data at step (b).

17. The data consistency detection method of claim 16, wherein the second memory is capable of storing a plurality of arithmetic operation results; and
step (g) includes the step of performing an arithmetic operation assigned to a data segment which corresponds to the reference data read from the first memory at step (c) on at least one of the reference data and the plurality of arithmetic operation results stored in the second memory to store a result of the arithmetic operation in the second memory.
